(19) United States
(12) Patent Application Publication
(10) Pub. No.: US 2026/0092008 A1
(43) Pub. Date: Apr. 2, 2026

(54) METHOD, SYSTEM, AND APPARATUS FOR MINERALIZATION OF CARBON DIOXIDE WITH INDUSTRIAL ALKALI WASTE

(71) Applicant: Pramod Dhanaji Patil, Sugar Land, TX (US)

(72) Inventor: Pramod Dhanaji Patil, Sugar Land, TX (US)

(21) Appl. No.: 18/901,963

(22) Filed: Sep. 30, 2024

(51) Int. Cl. C04B 22/10; B01D 21/26

(52) U.S. Cl. CPC C04B 22/10; B01D 21/267

(57) ABSTRACT

A method for mineralization of carbon dioxide includes mixing a solvent blend including dissolved carbon dioxide with an industrial alkali waste material to obtain a first slurry. The first slurry is directed to an inlet of a modified hydrocyclone configured as a carbon dioxide mineralization reactor, causing the first slurry to move in the modified hydrocyclone with controlled fluid dynamics such that surface interaction between particles of the industrial alkali waste material and the solvent blend is increased to form a first solid carbonated slag in less than a predefined threshold time with a carbonation rate greater than a predefined threshold. The first solid carbonated slag is released in a first stage from an underflow section of the modified hydrocyclone while concurrently regenerating and releasing the solvent blend devoid of carbon dioxide for reuse from an overflow section of the modified hydrocyclone.

### FIELD OF TECHNOLOGY

The present disclosure relates generally to a field of carbon dioxide (CO₂) sequestration. More specifically, the present disclosure relates to a method for mineralization of carbon dioxide with industrial alkali waste (i.e., mineral carbonation), a system for mineralization of carbon dioxide with industrial alkali waste and an apparatus for mineralization of carbon dioxide with industrial alkali waste.

### BACKGROUND

Climate change, driven primarily by anthropogenic carbon dioxide (CO₂) emissions, presents one of the most significant challenges of our time. As the world transitions towards more sustainable energy sources, there is an urgent need for effective CO₂ sequestration technologies to mitigate the impact of existing and future emissions. Conventional approaches to carbon dioxide (CO₂) sequestration, e.g., carbon capture, utilization, and storage (CCUS), have shown promise but face significant hurdles not only in terms of efficiency, cost-effectiveness, and scalability, but also usability and sustainability.

Current direct CO₂ sequestration methods, particularly those involving subsurface storage or enhanced oil recovery (EOR), suffer from several drawbacks. Such direct CO₂ sequestration methods often require substantial energy input, potentially offsetting some of the carbon reduction benefits. In the case of CO₂ EOR, the overall carbon footprint reduction can be limited. Additionally, costs associated with capturing, storing, and injecting CO₂ are prohibitively high, making widespread adoption economically challenging. Furthermore, subsurface injection of CO₂ does not generate any marketable products, limiting the economic incentives for implementation. As a result of aforementioned challenges, many CCUS projects have fallen behind schedule and are struggling to meet the projected CO₂ sequestration targets necessary to achieve net-zero emissions goals.

There is a growing recognition of the potential for mineral carbonation as an alternative approach to CO₂ sequestration. The process involves the reaction of CO₂ with alkaline materials to form stable carbonate minerals, effectively locking away the carbon in a solid form. Industrial alkali wastes, such as steel blast furnace slag, cement kiln dust, and fly ash, present an attractive feedstock for such processes due to their abundance and alkaline nature. However, existing mineral carbonation technologies face their own set of challenges. Conventional methods of mineralization of CO₂ have high complexity that require multiple steps and complex equipment, not only increasing operational complexity and cost, but also the time span of mineral carbonation. Typically, conventional mineral carbonation processes are very time and resource-intensive, thereby limiting throughput and scalability. The current systems, conventional reactors, and methods are inefficient due to technical challenges in balancing reaction time and resources for adequate contact between CO₂ and the alkaline materials, thereby adversely affecting overall conversion efficiency. For example, the resulting carbonated materials from conventional methods may have limited use, reducing the overall economic viability of the process, and typically, wastewater is generated in the conventional methods.

Further limitations and disadvantages of conventional and traditional approaches will become apparent to one of skill in the art through comparison of such systems with some aspects of the present disclosure as set forth in the remainder of the present application with reference to the drawings.

### BRIEF SUMMARY OF THE DISCLOSURE

A method, a system, and an apparatus for mineralization of carbon dioxide with industrial alkali waste, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not-to-scale. Wherever possible, like elements have been indicated by identical numbers.

Embodiments of the present disclosure will now be described, by way of example only, with reference to the following diagrams wherein:

FIG. 1 is a block diagram of a system for mineralization of carbon dioxide, in accordance with an embodiment of the present disclosure;

FIGS. 2A, 2B, 2C, and 2D are diagrams illustrating different views of an apparatus for mineralization of carbon dioxide, in accordance with an embodiment of the present disclosure;

FIG. 3 is a block diagram of a system for mineralization of carbon dioxide, in accordance with another embodiment of the present disclosure;

FIGS. 4A and 4B collectively is a flowchart illustrating a method for mineralization of carbon dioxide, in accordance with an embodiment of the present disclosure; and

FIG. 5 is a diagram illustrating exemplary operations for mineralization of carbon dioxide, in accordance with an embodiment of the present disclosure.

### DETAILED DESCRIPTION OF THE DISCLOSURE

Certain embodiments of the disclosure may be found in a method, a system, and an apparatus for mineralization of carbon dioxide with an industrial alkali waste repeater system. The method, the system, and the apparatus for mineralization of carbon dioxide with industrial alkali waste of the present disclosure uniquely combines the sequestration of carbon dioxide with the repurposing of industrial alkali waste materials, offering a dual environmental benefit.

Unlike conventional methods that require about 8 hours (generally, more than 8 hours in practice in most conventional systems) and complex equipment to perform the mineralization of carbon dioxide, the disclosed method significantly reduces the cycle time of mineralization of carbon dioxide by more than 97%. It is experimentally observed that the entire reaction of mineralization of carbon dioxide with the industrial alkali waste is completed in about 1-15 minutes, mostly less than 5 minutes. In some other implementations, when a catalyst is used, it further reduces to 1-2 minutes. Furthermore, advantageously, not only the cycle time of mineralization of carbon dioxide is reduced by more than 97%, but a high conversion rate (mineral carbonation) of more than 90% of available calcium and magnesium oxides is achieved in the present disclosure even within such drastically reduced time of 1-15 minutes.

Furthermore, unlike the conventional methods and systems (where typically final solids consist of carbonates and carbonated precursor and wastewater), the disclosed system and method is smartly designed and developed to regenerate more than 97% (e.g., 97-99.9%) of the input carbon dioxide dissolving solvent (i.e., continuous solvent regeneration) that is used initially to dissolve the carbon dioxide, providing a true zero-waste system. The source of carbon dioxide may be pure carbon dioxide or a flue gas comprising carbon dioxide. The disclosed method and system mineralize industrial waste material like steel blast furnace slag, cement kiln dust, or fly ash into useful products of practical utility that have an advantage in sequestering CO₂ permanently in industry waste material. This produced material can replace or become a significant part of high-energy-intensity material like cement. The resulting output product may have a dual impact in terms of CO₂ reduction and removal.

Furthermore, the disclosed method is flexible and may handle various types of industrial alkali waste materials like steel blast furnace slag, cement kiln dust, or fly ash without any noticeable impact on process cycle time and quality of output product (i.e., solid carbonated slag-based product). Further, the system and method of the present disclosure may operate at relatively lower temperatures as compared to conventional methods and systems, thereby enhancing energy efficiency.

In the following description, reference is made to the accompanying drawings, which form a part hereof, and in which are shown, by way of illustration, various embodiments of the present disclosure.

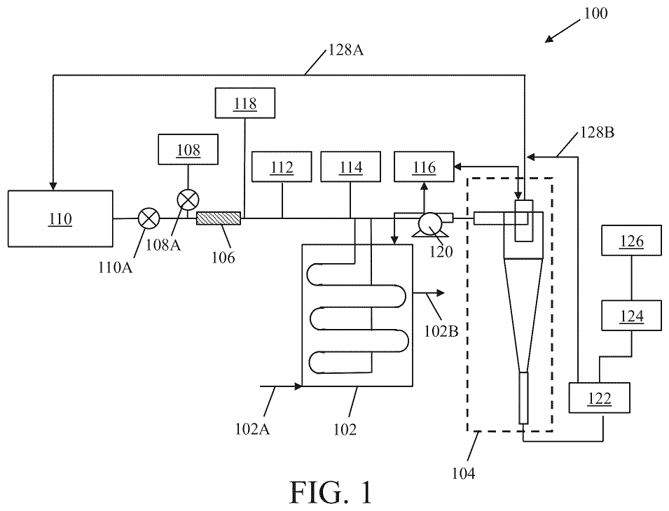

FIG. 1 is a block diagram of a system for mineralization of carbon dioxide (CO₂), in accordance with an embodiment of the present disclosure. With reference to FIG. 1, there is shown a block diagram of a system 100. The system 100 includes a chamber 102 and an apparatus 104 operatively and fluidly coupled to the chamber 102. The system 100 further includes a mixer 106 operatively and fluidly coupled to the chamber 102. The mixer 106 is operatively and fluidly coupled to a defined CO₂ source 108 and a CO₂-dissolving solution source 110 (i.e., a solution of CO₂ dissolving solvent and distilled water).

In an implementation, the system 100 may further include a first flow indicator 108A positioned at an outlet of the defined CO₂ source 108. The first flow indicator 108A may be configured to measure and control a flow of CO₂ into the mixer 106. Similarly, the system 100 may further include a second flow indicator 110A positioned at an outlet of the solution source 110. The second flow indicator 110A is configured to measure and control the flow of the CO₂-dissolving solution into the mixer 106.

The system 100 may further include an industrial alkali waste material source 112 and a metal catalyst source 114 operatively and fluidly coupled to the chamber 102. The system 100 may further include a controller 116 communicatively coupled to the system 100 and its components. The system 100 may further include a gas vent 118 placed between the chamber 102 and the mixer 106. Specifically, the gas vent 118 is positioned at an outlet of the mixer 106. The system 100 may further include a separator 122 fluidly coupled to the apparatus 104. Further, the system 100 includes one or more dryers 124 operably coupled to the separator 122. Furthermore, the system 100 may include a final product packaging unit 126 operably coupled to the one or more dryers 124.

In an implementation, the present disclosure provides the system 100 for the mineralization of CO₂, where the CO₂ from the defined CO₂ source 108 (e.g., pure CO₂ or impure CO₂ as a flue gas) is introduced into the mixer 106 along with a CO₂-dissolving solution from the CO₂-dissolving solution source 110. The solution includes a carbon dioxide-dissolving solvent and distilled water. The CO₂ and the solution are mixed in the mixer 106, which facilitates an interaction between the CO₂ and the CO₂-dissolving solution to obtain a solvent blend including dissolved CO₂. The solvent blend is then fed into the chamber 102. Simultaneously, industrial alkali waste material from the industrial alkali waste material source 112 and a metal catalyst from the metal catalyst source 114 may be introduced into the chamber 102 in an implementation, where the industrial alkali waste material and the metal catalyst react with the solvent blend to obtain a first slurry. Further, the obtained first slurry is fed into the apparatus 104 for a reaction that results in the formation of stable mineral compounds, effectively sequestering the CO₂. The apparatus 104 fluidly coupled to the chamber 102 controls the flow and processing of materials, while the controller 116 manages an overall operation of the system 100 to optimize the mineralization process. This integration of components allows for effective and efficient CO₂ capture and conversion into stable minerals in usable form (i.e., solid carbonated slag having practical use) in about 1-15 minutes (mostly less than 5 minutes), addressing the limitations of existing carbon sequestration methods. For example, 1 ton of CO₂ may be converted by the system 100 by reacting it with industrial alkali waste material like steel blast furnace slag or cement kiln dust or fly ash, to produce 2.5 to 4.5 tons of a solid carbonated slag-based product (e.g., pure or mixed carbonated minerals or supplemental cementitious material), which is a usable end-product. For example, the solid carbonated slag-based product produced from the system 100 may be readily used, for example, in road construction, building, and construction industry, polymer & paint, paper and other oil and gas applications.

The chamber 102 refers to a mixing and reaction vessel where an initial interaction between the solvent blend (containing dissolved CO₂), the industrial alkali waste material, and the metal catalyst occurs. The chamber 102 serves as a pre-processing stage before the first slurry enters the apparatus 104. In one embodiment, the chamber 102 is a heating chamber. In such an embodiment, the chamber 102 has an inlet 102A for heat intake from a heat source and an outlet 102B for heat exit back to the heat source. The heating chamber (i.e., the chamber 102) is configured to control the temperature of a mixture, which may significantly influence the reaction kinetics.

The chamber 102 may include a loop pathway or a predefined movement pattern to facilitate thorough mixing of the components. The loop pathway or the predefined movement pattern ensures that the industrial alkali waste material is well-dispersed in the solvent blend, promoting efficient surface contact between the reactants. A retention time of the first slurry in the chamber 102 is controlled to optimize an initial reaction and mixing process. It is to be understood that the retention time may vary based on the length of the loop pathway in an example.

In some embodiments, the chamber 102 may be designed and configured with different geometries or internal structures to enhance mixing. Some other examples of the chamber 102 may include, but are not limited to, baffles, static mixers, or agitation mechanisms without limiting the scope of the disclosure.

The chamber 102 is configured to handle various types of industrial alkali waste materials, including but not limited to steel slag (either crushed or granulated), cement kiln dust, and fly ash. In some cases, the chamber 102 may also accommodate pure calcium oxide as an alkali source. In some embodiments, the chamber 102 may also be equipped with sensors and monitoring devices to track parameters such as temperature, pH, and composition of the first slurry. Tracking of the parameters and associated measurements measured from the sensors and the monitoring devices may be used by the controller 116 to adjust process conditions in real-time for optimal performance. In some embodiments, the chamber 102 may be pressurized to enhance the dissolution of CO₂ in the carbon dioxide-dissolving solvent and to promote the initial stages of a mineral carbonation process.

Throughout the present disclosure, the term “mineral carbonation process” refers to a process in which carbon dioxide (CO₂) is transformed into solid carbonate minerals through a chemical reaction with metal-containing minerals. In the mineral carbonation process, CO₂ reacts with naturally occurring or synthetic minerals containing alkaline earth metals to form stable carbonate compounds. The mineral carbonation process is employed for the permanent sequestration of CO₂, converting the carbon dioxide from a gas into a stable solid form that may be safely stored or utilized.

The apparatus 104 refers to a special-purpose reactor designed and configured for a mineral carbonation process. In an embodiment, the apparatus 104 may be a modified hydrocyclone configured as the carbon dioxide mineralization reactor. The apparatus 104 is configured to facilitate rapid mineral carbonation of the industrial alkali waste material while simultaneously separating the products and regenerating the CO₂-disolving solvent. The apparatus 104 includes one or more sections including an overflow section, an underflow section, a vortex-creating component positioned within the overflow section, and a conical section. The apparatus 104 further includes an inlet connected to the overflow section, configured to receive the first slurry from the chamber 102. In some implementations, a slurry pump 120 is configured to feed the first slurry into the inlet of the apparatus 104 from the chamber 102. In some examples, dimensions and dimension ratios of the one or more sections may be optimized for the mineral carbonation process, as per application requirements. The one or more sections work together to create controlled fluid dynamics essential for the mineral carbonation process and associated chemical reactions. In some embodiment, the apparatus 104 may be configured as a modified hydrocyclone configured as the carbon dioxide mineralization reactor.

The mixer 106 refers to a device that is configured to blend a gas with a liquid. In some implementations, the mixer 106 may be a static mixer, a dynamic mixer, or any other suitable mixing device that may effectively mix the CO₂ gas in the CO₂-dissolving solvent (or CO₂-dissolving solution). Alternatively, in an exemplary implementation, the mixer 106 may operate under pressure to enhance dissolution of a gas, with pressures ranging from 1 to 20 bar. Further, temperature control mechanisms may be incorporated to maintain optimal dissolution conditions, between 10 degrees Celsius (° C.) to 50° C. In some implementations, the mixer 106 may also include inline monitoring devices to measure the concentration of the gas (e.g., carbon dioxide) in real-time, ensuring consistent saturation levels. In some implementations, the pressure and temperature control may not be required in the mixer 106.

The defined CO₂ source 108 refers to any suitable source of carbon dioxide that may supply CO₂ to the system 100 for mineralization of CO₂. In this case, the defined CO₂ source 108 may be an industrial flue gas comprising CO₂ or a purified CO₂ stream. In a case where the defined CO₂ source 108 is the industrial flue gas, additional gases other than the CO₂ may be vented out from the gas vent 118 after the CO₂ is dissolved in the CO₂-dissolving solvent in the mixer 106 to obtain a solvent blend. It is to be understood by a person of ordinary skill in the art (POSITA) that different carbon capture methods and systems may be used without limiting the scope of the disclosure. For example, when the defined CO₂ source 108 is the industrial flue gas, the system 100 may incorporate pre-treatment units such as desulfurization or dehumidification to ensure the CO₂ stream's quality. As long as CO₂ is present in sufficient quantity in the defined CO₂ source 108, any carbon capture methods may be used. A flow rate of CO₂ released from the defined CO₂ source 108 may be regulated to match capacity and a predefined carbonation rate of the system 100.

Throughout the present disclosure, the term “carbonation rate” refers to a rate at which carbon dioxide reacts with a substance, typically an alkaline material, to form stable carbonates. The carbonation rate is influenced by factors such as the concentration of CO₂, temperature, pressure, and availability of reactive materials in the system 100. The carbonation rate determines how quickly and efficiently CO₂ may be mineralized or converted into solid carbonates.

A CO₂ concentration in a supply of CO₂ from the defined CO₂ source 108 may vary between 1 to 100%. In some examples, a preferred range of the CO₂ concentration from the defined CO₂ source 108 may be between 10% and 100%. In other examples, a range of the CO₂ concentration from the defined CO₂ source 108 may be between 25% and 100%. Additionally, another range may be between 30% and 100%. In other examples, a more preferred range of the CO₂ concentration from the defined CO₂ source 108 may be between 50% and 100%. In some other examples, most preferably, the CO₂ concentration from the defined CO₂ source 108 may be 100% or near 100% (pure CO₂).

The CO₂-dissolving solution source 110 refers to a supply of the CO₂-dissolving solution. The CO₂-dissolving solution source 110 may include storage tanks, pumping systems, and inline blending capabilities to ensure consistent solution composition. In an exemplary implementation temperature control and agitation mechanisms may be incorporated into the CO₂-dissolving solution source 110 to maintain solvent stability and performance, without limiting the scope of the disclosure.

The CO₂-dissolving solution source 110 provides the solution including the CO₂-dissolving solvent and the distilled water. The CO₂-dissolving solvent may include, but is not limited to, primary, secondary, tertiary, or quaternary amines, or other CO₂-soluble compounds such as sodium glycinate. Some examples of amines used as the CO₂-dissolving solvent may include, but not limited to, mono-ethanol amine, di-ethanol amine, and methyl di-ethanol amine.

The industrial alkali waste material source 112 refers to a supply of reactive materials for CO₂ mineralization. The industrial alkali waste material source 112 may supply various materials including, but not limited to, steel slag (crushed or granulated), cement kiln dust, fly ash, or pure calcium oxide. In some embodiments, the industrial alkali waste material source 112 may include pre-treatment capabilities such as grinding, sieving, or chemical activation to prepare the industrial alkali waste material for the mineral carbonation process. The particle size distribution of the industrial alkali waste material may be controlled to optimize reactivity. In some examples, the particle size distribution of the industrial alkali waste material may be ranging from 1 micrometer (μm) to 1000 μm. In some other examples, the particle size distribution of the industrial alkali waste material may have a preferred range of 10 μm to 500 μm.

The metal catalyst source 114 refers to a supply of catalysts used to enhance the mineral carbonation process. The metal catalyst source 114 may include, but is not limited to, nanoparticles of metals such as nickel, cobalt, or platinum. In some implementations, the metal catalyst source 114 may further include precision dosing systems, dispersion mechanisms, and safeguards to handle potentially reactive materials. In some embodiments, the metal catalyst may be supported on carrier materials to enhance distribution and recovery. In some implementations, metal catalyst may not be used depending on the cycle time of the mineral carbonation process to be achieved. For example, metal catalyst when used may further reduce the cycle time of the mineral carbonation process to less than 1 minute.

The controller 116 refers to a computational element that is operable to manage the overall operation of the mineral carbonation process, i.e., manages the overall operation of the system 100. The controller 116 may control flow rates, mixing ratios, reaction conditions, and monitor various parameters throughout the process. The controller 116 may incorporate multiple sensors, including but not limited to pH meters, temperature probes, pressure sensors, and composition analyzers at various locations in the system 100. In some implementations, the controller 116 may use advanced control operations, potentially including machine learning or artificial intelligence, to optimize the mineral carbonation process in real-time. The controller 116 may adjust operational parameters such as feed rates, temperatures, and pressures to maintain performance of the system 100 under varying input conditions. In some examples, the controller 116 may further manage safety protocols, system start-up and shut-down procedures, and provide data logging and reporting capabilities.

The gas vent 118 refers to a device designed to release non-CO₂ gases from the system 100 after the mixing process in the mixer 106. The gas vent 118 allows for a selective removal of unwanted gases while retaining a CO₂-rich mixture for further processing. In some embodiments, the gas vent 118 may include selective membranes or pressure-swing systems to efficiently separate CO₂ from other gases. The gas vent 118 facilitates maintaining the predefined CO₂ concentration in the solvent blend and prevents the accumulation of inert or potentially interfering gases in the subsequent stages of the mineral carbonation process.

The separator 122 refers to a device configured to separate a solid carbonated product from any remaining liquid after the chemical reaction in the apparatus 104. In some embodiments, the separator 122 may include, but not limited to, a centrifuge, filter, or another type of solid-liquid separation equipment. In an example, the separator 122 may be used to recover the solid carbonated minerals produced in the chemical reaction in the apparatus 104.

The one or more dryers 124 are configured to remove residual moisture from the separated solid carbonated product. In some embodiments, the one or more dryers may include, but not limited to, a fluidized bed dryer, rotary dryer, or another type of drying equipment. The purpose of the one or more dryers 124 is to produce a dry, final carbonated mineral product suitable for storage or further use.

The final product packaging unit 126 refers to equipment configured to package the dried, carbonated mineral product for storage, transport, or distribution. The final product packaging unit 126 may include bagging machinery, bulk packaging systems, or other appropriate packaging systems suitable for handling and preserving the properties of the carbonated mineral product. The final product packaging unit 126 may also be referred to as carbonated slag-based product packaging station, which ensures that end product of the CO₂ mineralization process is properly contained and ready for its intended use or further processing.

In operation, the mixer 106 is configured to blend carbon dioxide in a gaseous form captured from the defined carbon dioxide source 108 (e.g., pure CO₂ or impure CO₂ from a flue gas containing CO₂) into the solution including the carbon dioxide-dissolving solvent and the distilled water to obtain the solvent blend including the dissolved carbon dioxide. Specifically, the mixer 106 is configured to efficiently dissolve CO₂ in the gaseous form into a liquid medium (i.e. the solution including the carbon dioxide-dissolving solvent and the distilled water), creating a CO₂-rich solution ready for the mineral carbonation process. The CO₂ is dissolved in the carbon dioxide-dissolving solvent of the solution with a loading ranging from 0.001 moles to 0.6 moles of CO₂ per mole of the carbon dioxide-dissolving solvent. In some examples, the CO₂ loading may be from 0.01 moles to 0.5 moles of CO₂ per mole of the carbon dioxide-dissolving solvent. In other examples, a range of CO₂ loading may be from 0.1 moles to 0.4 moles of CO₂ per mole of the carbon dioxide-dissolving solvent. In some implementations, a range of the CO₂ loading may range from 0.2 moles to 0.3 moles of CO₂ per mole of the carbon dioxide-dissolving solvent. The mixer 106 ensures thorough gas-liquid contact, maximizing CO₂ dissolution and achieving a consistent concentration throughout the solvent blend. This pre-dissolution step not only prepares the CO₂ in a dissolved form that is more readily available for reaction with the industrial alkali waste material but also allows for better control and measurement of the CO₂ input into the system 100, simplifying the process.

In accordance with an embodiment, the CO₂-dissolving solvent may include, but is not limited to, primary, secondary, tertiary, or quaternary amines, or other CO₂-soluble compounds such as sodium glycinate. Some examples of amines used as the CO₂-dissolving solvent may include, but are not limited to mono-ethanol amine, di-ethanol amine, or methyl di-ethanol amine. In some implementations, a ratio of the CO₂-dissolving solvent to water in the solution may be adjusted between 1% solvent and 99% water to 99% solvent and 1% water. In some examples, a preferred range for the ratio of the CO₂-dissolving solvent-to-water may be between 20% solvent and 80% water to 80% solvent and 20% water. In yet other examples, another preferred range for the ratio of the CO₂-dissolving solvent-to-water may be between 30% solvent and 70% water to 70% solvent and 30% water. Further, in some implementations, the range for the ratio of the CO₂-dissolving solvent-to-water may be between 40% solvent and 60% water to 60% solvent and 40% water. Additionally, in some examples, the range for the ratio of the CO₂-dissolving solvent-to-water may be between 50% solvent and 50% water, ensuring an optimal balance for certain CO₂-dissolving conditions.

In some implementations, the pH of the CO₂-dissolving solvent may vary between 9 and 14. In some examples, the pH of the CO₂-dissolving solvent may fall within a range of 10 to 13. In other examples, the pH of the CO₂-dissolving solvent may vary between 11 to 12. In some cases, the pH of the CO₂-dissolving solvent may vary between 12 and 13.

In an implementations, after blending the carbon dioxide into the solution to obtain the solvent blend, the industrial alkali waste material from the industrial alkali waste material source 112 may be added to the solvent blend. Further, the chamber 102 is configured to mix the solvent blend including the dissolved carbon dioxide with the industrial alkali waste material to obtain the first slurry. As the solvent blend enters the chamber 102, the solvent blend interacts with the industrial alkali waste material, which is introduced simultaneously or sequentially. In an implementations, a feed rate of the industrial alkali waste materials at which may be adjusted according to CO₂ input and predefined stoichiometric ratios. In one embodiment, an amount of the industrial alkali waste material fed into the chamber 102 of the system 100 may be proportional to a weight of the CO₂-dissolving solvent used in the solvent blend. For instance, in some examples, the amount of the industrial alkali waste material fed into the chamber 102 may range from 0.1 to 10 times the weight of the CO₂-dissolving solvent in the solvent blend, according to specific application requirements. In other examples, a preferred range of the amount of the industrial alkali waste material fed into the chamber 102 may range from 1 to 5 times the weight of the CO₂-dissolving solvent in the solvent blend. In some other examples, a more preferred range of the amount of the industrial alkali waste material fed into the chamber 102 may range from 1 to 3 times the weight of the CO₂-dissolving solvent in the solvent blend. The mixing action ensures uniform distribution of the dissolved CO₂ throughout the industrial alkali waste material, initiating early stages of the carbonation process. In the mixing operation, a homogeneous slurry is formed where particles of the industrial alkali waste material are surrounded and encounters the solvent blend. This maximizes the surface area available for reaction, promoting efficient mass transfer between the liquid and solid phases. Additionally, the mixing action helps to break down any agglomerates in the industrial alkali waste material, further increasing the reactive surface area. Alternatively stated, by initial mixing in the chamber 102, the reactants of the first slurry are preconditioned before the first slurry enters the apparatus 104. By ensuring contact between the solvent blend and the industrial alkali waste material, the chamber 102 initiates the mineral carbonation process, potentially reducing the overall reaction time in the subsequent stages. The preconditioning of the reactants may lead to higher conversion rates and more efficient use of the CO₂ in the system 100, ultimately improving the overall performance and efficiency of the mineral carbonization process.

In an implementations, prior to feeding a mixture of the solvent blend and the industrial alkali waste material into the chamber 102, the metal catalyst from the metal catalyst source 114 may be added to the mixture to further reduce the cycle time of the mineral carbonation process. In some implementations, a concentration of the metal catalyst fed into the chamber 102 may range from 10 parts per million (ppm) to 500 ppm relative to the solution including the CO₂-dissolving solvent and the distilled water. In some examples, the concentration of the metal catalyst may range from 10 ppm to 200 ppm relative to the solution. In other examples, a preferred range of the concentration of the metal catalyst may vary between 10 ppm to 150 ppm relative to the solution. In some other examples, a more preferred range of the concentration of the metal catalyst fed into the chamber 102 may vary between 30 ppm to 100 ppm relative to the solution. In another example, a most preferred range of the concentration of the metal catalyst fed into the chamber 102 may vary between 50 ppm to 100 ppm relative to the solution. In some implementations, the controller 116 is configured to control introduction of the metal catalyst in the solvent blend in a range of 10-500 parts per million (ppm) of the solvent blend before directing the first slurry into the inlet of the apparatus 104 configured as the carbon dioxide mineralization reactor. Alternatively, in other implementations, the metal catalyst may not be required to be added to the mixture of the solvent blend and the industrial alkali waste material.

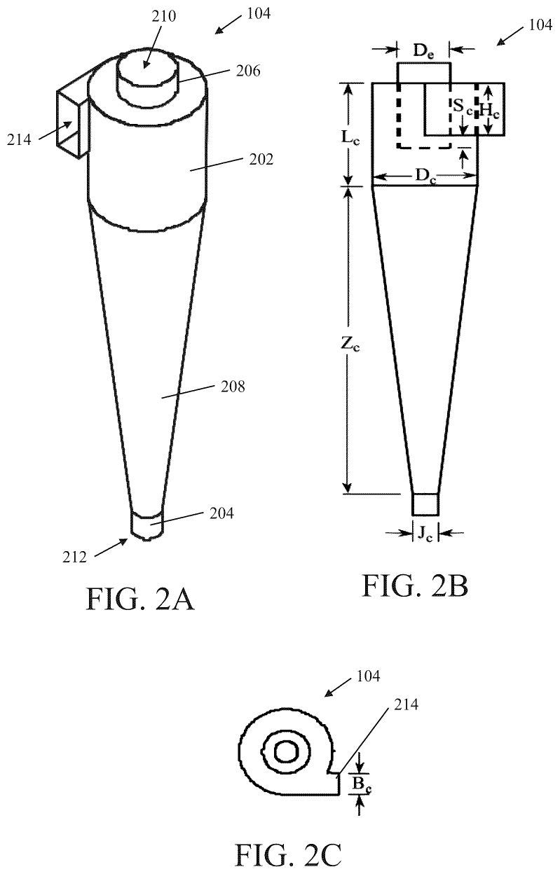

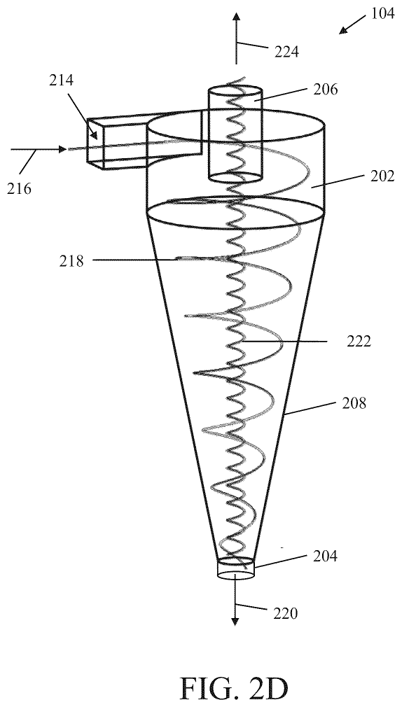

The apparatus 104 is configured as the carbon dioxide mineralization reactor. An example of the apparatus 104 configured as carbon dioxide mineralization reactor has been described in detail, for example, in FIGS. 2A to 2D. Specifically, the apparatus 104 is configured to receive the first slurry via an inlet of the apparatus 104. In an exemplary implementation, the apparatus 104 is specifically configured for tangential introduction. The introduction of the first slurry via the inlet of the apparatus 104 may initiate the controlled fluid dynamics for the mineral carbonation process immediately upon entry. Optimized dimensions and orientation of the inlet of the apparatus 104 maintain velocity and consistency of the first slurry, ensuring a smooth transition from the chamber 102 and inducing a spiral flow pattern. The tangential introduction converts linear momentum of the first slurry into rotational momentum, generating centrifugal forces central to the function of the apparatus 104. By receiving the preconditioned slurry in such manner, the apparatus 104 seamlessly integrates the mixing process from the chamber 102 with its more intensive reaction environment. The controlled introduction of the first slurry via the optimized inlet prevents clogging, ensures a consistent feed rate, and maintains the reactivity of components of the first slurry. Consequently, such configuration contributes to faster reaction kinetics, higher conversion rates, and overall improved efficiency and stability of the mineral carbonation process.

The apparatus 104 is further configured to cause the first slurry to move within the apparatus 104 with the controlled fluid dynamics such that surface interaction between particles of the industrial alkali waste material and the solvent blend is increased to form a first solid carbonated slag in less than a predefined threshold time with the carbonation rate greater than a predefined threshold. Specifically, the apparatus 104 includes a plurality of different sections that causes the first slurry to move within the apparatus 104 and creates the controlled fluid dynamics that facilitate and accelerate the mineral carbonation process. As the first slurry, including the solvent blend (solution with dissolved CO₂), the industrial alkali waste material, enters tangentially into the overflow section, the apparatus 104 generates a high-speed rotational flow. The high-speed rotational flow creates strong centrifugal forces in the cylindrical and conical sections, driving denser particles of the industrial alkali waste material towards walls of the apparatus 104. Concurrently, the geometry of the apparatus 104 establishes radial and axial pressure gradients. The vortex finder in the overflow section induces a central vortex, drawing the regenerated CO₂-dissolving solution towards a center of the apparatus 104 and upwards. In the conical section, decreasing diameter intensifies the rotational velocity and shear forces, enhancing interactions between the solvent blend and the industrial alkali waste material. The combination of centrifugal force, centripetal force, and gravitational force creates zones of intense turbulence and micro-mixing, particularly near the walls of the apparatus 104 and in the transition between the cylindrical section and the conical section. By creating the zones of intense turbulence and micro-mixing, frequent and high-energy collisions occur between the components of the first slurry. In some cases, the metal catalyst dispersed throughout the first slurry further accelerates the reaction involved in the mineral carbonation process at the zones in the apparatus 104. The first slurry within the overflow section of the apparatus 104 follows a controller flow pattern ensuring that fresh reactant surfaces are continuously exposed, maintaining a high carbonation rate throughout the mineral carbonation process. Further, by optimizing retention time of the first slurry in the apparatus 104 and reaction conditions within the apparatus 104, the apparatus 104 form the first solid carbonated slag in less than the predefined threshold time with the carbonation rate greater than the predefined threshold. In an implementation, beneficially, certain dimensional alterations of different sections of a hydrocyclone may be performed to be used as the apparatus 104. Advantageously, the structural modifications to the apparatus 104, which may be a modified hydrocyclone transforms the apparatus 104 into a highly efficient carbon dioxide mineralization reactor. The modifications, such as precise dimensional alterations, carefully calibrated and interrelated, create a synergistic effect that optimizes the fluid dynamics within the apparatus 104 in a manner specifically tailored for carbon dioxide mineralization. In an example, the details of the modification of the apparatus 104, has been explained in detail, for example, in the FIGS. 2A to 2D.

In an implementation, the predefined threshold time for the formation of the first solid carbonated slag is in a range of 1-15 minutes. In some examples, the controlled fluid dynamics enables the mineral carbonation process to occur in less than 5 minutes. In other examples, the mineral carbonation process may occur in less than 2 minutes. In some examples, most preferably, the mineral carbonation process may be completed in less than 1 minute. Such a rapid and efficient mineral carbonation process not only increases the overall CO₂ sequestration capacity of the system 100 but also improves the quality and consistency of the solid carbonated product, potentially enhancing its value for subsequent applications.

In some implementations, the predefined threshold for the carbonation rate is in a range of 50-99% based on the predefined threshold time. In some examples, the carbonation rate may preferably exceed 95% of the available alkali content in the industrial alkali waste material. In some examples, the carbonation rate may more preferably exceed 95% of the available alkali content in the industrial alkali waste material. In other examples, the carbonation rate may most preferably reach up to 99% of the available alkali content in the industrial alkali waste material.

The apparatus 104 is further configured to release the first solid carbonated slag in a first stage from the underflow section of the apparatus 104 while concurrently regenerating and releasing the solvent blend devoid of carbon dioxide for reuse from the overflow section of the apparatus 104. Specifically, the apparatus 104 is engineered to simultaneously release the first solid carbonated slag and regenerate the solvent blend. The simultaneous release of the first solid carbonated slag and regeneration of the solvent blend is achieved through the overflow section and the underflow section of the apparatus 104, which leverage the density differences created by the mineral carbonation process. As the first slurry moves through the apparatus 104, the first solid carbonated slag, being denser, is directed towards the walls and down to the underflow section of the apparatus 104 by the centrifugal forces. Thus, the first solid carbonated slag is efficiently separated and released for further processing. Concurrently, the solvent blend devoid of carbon dioxide, being lighter, is drawn towards the center of the apparatus 104 by the pressure gradient and upwards through the vortex finder to the overflow section of the apparatus 104. The solvent blend devoid of carbon dioxide is released to the CO₂-dissolving solution source 110, as shown by a flow of the regenerated solvent blend indicated by a solid arrow 128A. Such continuous, simultaneous separation process ensures that the mineral carbonation process proceeds uninterrupted, maximizing efficiency. The regenerated solvent blend, now devoid of CO₂, is immediately available for reuse, reducing the need for fresh solvent and minimizing waste. Such approach involving the simultaneous release of the first solid carbonated slag and regeneration of the solvent blend not only streamlines the overall process but also contributes to economic viability and environmental sustainability of the system 100 by optimizing resource utilization and maintaining a closed-loop operation.

In an implementation, the industrial alkali waste material may be a porous media where the CO₂-dissolvoing solvent impregnates into the porous media of the industrial alkali waste material under the influence of the centrifugal force generated by the apparatus 104. The centrifugal force drives the CO₂-dissolving solvent deep into pores of the porous media of the industrial alkali waste material, significantly increasing the effective reaction surface area.

In an implementation, during the mineral carbonation process, the industrial alkali waste material, such as steel blast furnace slag, undergoes a series of reactions to form carbonated slag. Initially, the calcium oxide (CaO) in the steel blast furnace slag reacts with water to form calcium hydroxide: CaO+H₂O→Ca(OH)₂. Simultaneously, the CO₂ dissolved in the amine solvent dissociates in water: CO₂+H₂O [symbol] H₂CO₃ [symbol] H⁺+HCO³⁻ [symbol] H⁺+CO₃²⁻. The key carbonation reaction then occurs between the calcium hydroxide and carbon dioxide: Ca(OH)₂+CO₂→CaCO₃+H₂O, forming calcium carbonate. For magnesium-containing components in the steel blast furnace slag, similar reactions take place: MgO+H₂O→Mg(OH)₂, followed by Mg(OH)₂+CO₂→MgCO₃+H₂O. Such reactions happen concurrently within the apparatus 104, where the controlled fluid dynamics created by the design of the apparatus 104 enhance the interaction between slag particles and the CO₂-dissolving solvent. The resulting product is the first solid carbonated slag, in some examples, primarily composed of calcium and magnesium carbonates, which effectively sequesters the input CO₂ in a stable mineral form. The mineral carbonation process not only captures and stores the CO₂ but also transforms industrial waste into a usable carbonated product with potential applications in construction and other industries.

In some examples, the carbonated products resulting from the disclosed mineral carbonation process have diverse applications across multiple industries. The carbonated products, such as carbonated slag, carbonated kiln dust, or carbonated fly ash, may be blended with cement in proportions of up to 50% by weight for use in road construction and various building applications. The blending of the carbonated product with cement not only provides a sustainable solution for large-scale utilization of these products but also enhances the properties of the resulting construction materials. Additionally, the carbonated products find application in oil well cementing and drilling operations, offering improved performance characteristics in such specialized contexts. In cases where the process produces pure calcium carbonate (CaCO₃) through the reaction of carbon dioxide with calcium oxide (CaO), the applications extend even further. The high-purity CaCO₃ may be utilized in building and construction sectors, incorporated into polymer formulations and paints to enhance their properties, and employed in various oil and gas industry applications. The wide range of potential uses for the carbonated products underscores the versatility and economic viability of the mineral carbonation process, providing environmentally beneficial alternatives across multiple sectors of industry.

In an implementation, the separator 122 is configured to generate a second solid carbonated slag in a second stage by causing the first solid carbonated slag to pass through a forced centrifugal force in the separator 122 to further segregate at least a portion of the solvent blend for further reuse from the first solid carbonated slag obtained in the first stage from the apparatus 104. Specifically, the separator 122 is configured to further refine the mineral carbonation process, generating the second solid carbonated slag through an additional stage of processing. Generation of the second solid carbonated slag is accomplished by subjecting the first solid carbonated slag, obtained from the apparatus 104, to intense centrifugal forces. As the first solid carbonated slag passes through the separator 122, the forced centrifugal force act to further separate any remaining solvent blend from the solid particles of the first solid carbonated slag, enhancing a purity of the solid carbonated product. The separator 122 allows for an efficient extraction of residual solvent blend devoid of CO₂, which is then recirculated for reuse in the system 100. The solvent blend devoid of carbon dioxide is further released to the CO₂-dissolving solution source 110, as shown by a flow of the regenerated solvent blend indicated by a solid arrow 128B. Further separation of the solid particles of the first solid carbonated slag in the second stage not only improves the quality and consistency of a final carbonated product but also maximizes the recovery and reuse of the valuable solvent blend. By implementing the second stage, the overall efficiency of the mineral carbonation process is significantly increased. The resulting second solid carbonated slag exhibits improved characteristics, potentially enhancing its value for various applications. Simultaneously, the recovery of additional solvent reduces operational costs and minimizes waste, contributing to the economic and environmental sustainability of the entire process.

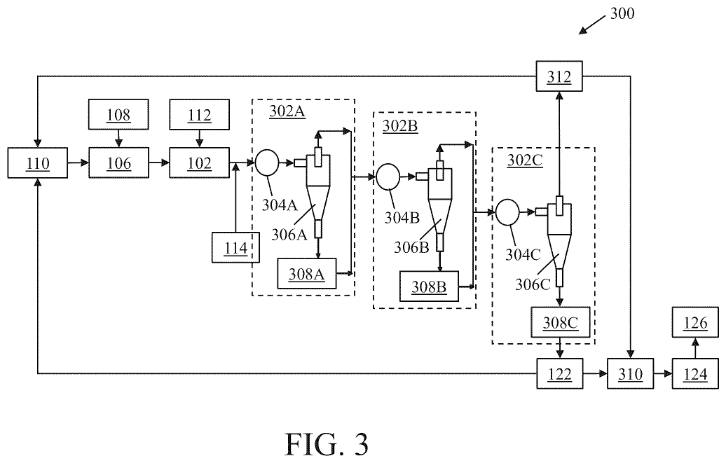

In some implementations, the system 100 may include more than two stages for refinement of the solid carbonated product, described in detail, for example, in FIG. 3. Such a multi-stage approach to product refinement and resource recovery demonstrates optimization of the conversion of CO₂ into stable mineral form while maximizing the recovery and reuse of process inputs such as solvents. The resulting high-quality carbonated product, coupled with the efficient use of resources, showcases capability of the system 100 to effectively address both carbon sequestration and waste management challenges in a single, integrated process.

In an implementation, the one or more dryers 124 is configured to generate a solid carbonated slag-based product in one or more subsequent drying stages of the first solid carbonated slag obtained in the first stage or the second solid carbonated slag obtained in the second stage. The one or more dryers 124 in the system 100 are configured to produce a high-quality solid carbonated slag-based product through a series of carefully controlled drying stages. Such drying process may be applied to either the first solid carbonated slag from the apparatus 104 or the second solid carbonated slag from the separator 122, offering flexibility in a production line. The one or more dryers 124 utilize advanced thermal management and moisture removal techniques to gradually reduce the water content of the carbonated slag while preserving its valuable mineral structure. Such a staged drying approach allows for precise control over the product's final moisture content and physical properties. As the first solid carbonated slag obtained in the first stage or the second solid carbonated slag obtained in the second stage progresses through the series of carefully controlled drying stages, its handling characteristics improve, and any residual solvent is effectively removed. The resulting solid carbonated slag-based product exhibits enhanced stability, uniformity, and suitability for various applications, such as construction materials or soil amendments. By implementing multiple drying stages, the system 100 ensures thorough and consistent drying, preventing issues like agglomeration or degradation that may compromise product quality. Such refined drying process not only enhances the value and versatility of the final product but also contributes to the overall efficiency of the system 100 by ensuring that the captured carbon is effectively locked into a stable, useful form. The ability to fine-tune the drying process for different input materials further demonstrates adaptability and potential of the system 100 for diverse industrial applications.

FIGS. 2A, 2B, 2C, and 2D are diagrams illustrating different views of an apparatus for mineralization of carbon dioxide, in accordance with an embodiment of the present disclosure. FIGS. 2A-2D are described in conjunction with elements from FIG. 1. With reference to FIG. 2A, there is shown a perspective view of the apparatus 104 for mineralization of carbon dioxide. With reference to FIG. 2B, there is shown a view of the apparatus 104 with different sections. With reference to FIG. 2C, there is shown a top view of the apparatus 104 with an inlet 214. With reference to FIG. 2D, there is shown a view of a flow pattern of fluids in the apparatus 104.

Referring to the FIGS. 2A-2D, the apparatus 104 includes a plurality of different sections that include an overflow section 202, an underflow section 204, a vortex finder 206 positioned within the overflow section 202, and a cone section 208. Specifically, the overflow section 202 is disposed at the top portion of the apparatus 104, comprising the vortex finder 206. The overflow section 202 corresponds to the cylindrical body, which then transitions into the cone section 208. The conical shape of the apparatus 104 narrows towards the bottom of the apparatus 104, terminating in the underflow section 204 with a spigot. Further, the overflow section 202 includes an overflow outlet 210 and the underflow section 204 includes an underflow outlet 212. The apparatus 104 further includes an inlet 214 connected to the overflow section 202.

Advantageously, the structural modifications to the apparatus 104 (which may be a modified hydrocyclone) may transform the apparatus 104 into a highly efficient carbon dioxide mineralization reactor. These precise dimensional alterations, carefully calibrated and interrelated, create a synergistic effect that optimizes the fluid dynamics within the apparatus 104 in a manner specifically tailored for carbon dioxide mineralization. Thus, the apparatus 104 may be referred to as the apparatus 104 configured as the carbon dioxide mineralization reactor. The apparatus 104 (e.g., a modified hydrocyclone) is modified in terms of configuration (based on experimentation), comprising specific ratios between the different sections of the apparatus 104, which engenders a controlled turbulent environment. This environment may be precisely engineered to maximize the interfacial area between the industrial alkali waste particles and the carbon dioxide-laden solvent blend. The result is a significant enhancement in the kinetics of the carbonation reaction, leading to markedly improved efficiency and effectiveness in the mineralization process (i.e., the mineral carbonation process). The dimension of each section of the apparatus 104 and ratio of each section with respect to a diameter Dc of the overflow section 202 are precisely calibrated to improve the mineralization process (i.e., the mineral carbonation process). Various examples of the modification and calibrations (configurations) are given below, in an example.

In some implementations, the overflow section 202 of the apparatus 104 configured as the carbon dioxide mineralization reactor has a diameter Dc in a range of 0.08 meter to 1.2 meter. In some examples, the diameter De of the overflow section 202 may be in a preferred range of 0.1 meter to 1 meter. Adjusting the diameter De directly impacts the controlled fluid dynamics within the apparatus 104, particularly influencing both the capacity and flow rate of the first slurry. The adjustments to the diameter De optimize the surface interactions between particles of the industrial alkali waste material and the solvent blend, thereby enhancing the efficiency of the mineral carbonation process.

In some implementations, a diameter Jc of the underflow outlet 212 of the underflow section 204 of the apparatus 104 is in a range of one-third to one-fifth of the diameter Dc of the overflow section 202. In some examples, the diameter Jc of the underflow outlet 212 is in a preferred range of one-quarter to one-fifth of the diameter Dc of the overflow section 202. In some other examples, most preferably, the diameter Jc of the underflow outlet 212 is one-quarter of the diameter Dc of the overflow section 202. The diameter Jc of the underflow outlet 212 controls the release of the first solid carbonated slag. Specifically, adjusting the diameter Jc directly impacts an amount and quality of the first solid carbonated slag. By adjusting the diameter Jc of the underflow outlet 212 smaller, pressure at the base of the apparatus 104 is increased, ensuring that only well-reacted, dense particles of the first solid carbonated slag are discharged.

In some implementations, a diameter De of the vortex finder 206 or the overflow outlet 210 of the apparatus 104 is in a range of one-half to one-quarter of the diameter Dc of the overflow section 202. In some examples, the diameter De is in a preferred range of one-half to one-third of the diameter De of the overflow section 202. In some other examples, most preferably, the diameter De is one-half of the diameter Dc of the overflow section 202. In such implementations, the diameter De of the vortex finder 206 or the overflow outlet 210 of the apparatus 104 controls the amount of the solvent blend released through the overflow outlet 210 of the overflow section 202 of the apparatus 104. Specifically, the rate at which the amount of the solvent blend released in a given time, which is part of the controlled fluid dynamics of the apparatus 104, is influenced by adjusting the diameter De.

In some implementations, a spigot diameter Sc of the apparatus 104 is in a range of one-sixth to one-tenth of the diameter Dc of the overflow section 202. In some examples, the spigot diameter Sc of the apparatus 104 is in a preferred range of one-eighth to one-tenth of the diameter Dc of the overflow section 202. In some other examples, most preferably, the spigot diameter Sc of the apparatus 104 is one-eight of the diameter Dc of the overflow section 202. In some examples, adjusting the spigot diameter 104 increases velocity of the first slurry, potentially enhancing the centrifugal force applied to the first slurry.

In some implementations, a length Lc of the overflow section 202 representing a cylindrical body of the apparatus 104 is one of: either equal to the diameter Dc of the overflow section 202 or twice the diameter Dc of the overflow section 202. In some examples, the length Lc of the overflow section 202 is twice the diameter Dc of the overflow section 202. In some other examples, most preferably, the length Lc of the overflow section 202 is equivalent to the diameter Dc of the overflow section 202. The length Le of the overflow section 202 directly impacts the residence time of the first slurry within the apparatus 104. Thus, the residence time of the first slurry within the apparatus 104 is controlled by adjusting the length Lc of the overflow section 202.

In some implementations, a length Zc of the cone section 208 of the apparatus 104 is in a range of three times to five times of the diameter Dc of the overflow section 202. In some examples, most preferably, the length Zc of the cone section 208 is three times the diameter Dc of the overflow section 202. The length Zc is adjusted to directly influence the residence time of the first slurry within the cone section 208, with a longer cone providing increased residence time. This extended duration allows for more complete interaction between the industrial alkali waste material and the CO₂-dissolving solvent, thereby optimizing the carbonating reaction.

In some implementations, the inlet 214 of the apparatus 104 has a width Bc in a range of one-third to one-sixth of the diameter Dc of the overflow section 202. In some examples, the width Bc of the inlet 214 is in a preferred range of one-quarter to one-sixth of the diameter Dc of the overflow section 202. In some other examples, most preferably, the width Bc of the inlet 214 is one-quarter of the diameter Dc of the overflow section 202. Adjusting the width Bc directly impacts the controlled fluid dynamics within the apparatus 104, particularly influencing the velocity of the first slurry entering the apparatus 104 (i.e., the modified hydrocyclone). Moreover, adjusting the width Bc enhances the interaction between the porous media of the industrial alkali waste material and the solvent blend including the dissolved carbon dioxide, thereby promoting the mineral carbonation reaction.

In some implementations, the length Hc of the inlet 214 of the apparatus 104 is in a range of one-half to one-quarter of the diameter Dc of the overflow section 202. In some examples, the length Hc of the inlet 214 is in a preferred range of one-half to one-third of the diameter Dc of the overflow section 202. In some other examples, most preferably, the length Hc of the inlet 214 is one-half of the diameter Dc of the overflow section 202. The length Hc defines a distance over which the first slurry enters the apparatus 104, directly affecting an initial flow rate and velocity of the first slurry as it begins its movement through the apparatus 104, thereby impacting the efficiency of subsequent mixing and reactions.

Thus, it is observed that such structural modification yields multiple tangible benefits that directly address the technical challenges in carbon dioxide mineralization. In first example, the modified fluid dynamics substantially reduce the time required for carbonation, achieving the formation of solid carbonated slag in less than a predefined threshold time of 1-15 minutes, mostly less than 5 minutes, which is about 97% reduction than conventional time of about 8 hours. In a second example, the optimized particle-solvent interactions result in a carbonation rate that exceeds a predefined threshold, surpassing the capabilities of conventional systems. In a third example, the modified structure of the apparatus 104 enables simultaneous slag formation and CO₂-dissolving solvent regeneration, streamlining the overall process and improving resource efficiency. In a fourth example, the precisely defined dimensional relationships allow for scaling of the apparatus 104 while maintaining optimal performance across various operational capacities.

Referring to FIG. 2D, the apparatus 104 includes the inlet 214 through which the first slurry may enter tangentially, as indicated by a solid arrow 216. As the first slurry enters through the inlet 214, the first slurry may begin a spiraling motion, represented by curved lines within the apparatus 104. The spiraling motion of the first slurry forms a spiral flow pattern for the mineral carbonation process. The spiral flow pattern includes a primary vortex 218, closer to the walls of the apparatus 104, representing a flow of denser particles, including the industrial alkali waste material and forming carbonated slag. The industrial alkali waste material and forming carbonated slag are driven outward by centrifugal force as the industrial alkali waste material and forming carbonated slag move downward through the cone section 208, as indicated by a solid arrow 220.

The spiral flow pattern further includes a second vortex 222, closer to the center of the apparatus 104, representing the upward flow of the regenerated solvent blend devoid of carbon dioxide, as indicated by the solid arrow 224. The upward flow is facilitated by the vortex finder 206, which creates a low-pressure zone at the center of the apparatus 104. The spigot at the bottom of the underflow section 204 allows for the controlled release of the formed solid carbonated slag, while the vortex finder 206 in the overflow section 202 enables the collection of the regenerated solvent blend. The apparatus 104 enables simultaneous reaction, separation, and product collection, making the apparatus 104 highly efficient for the mineral carbonation process. The controlled fluid dynamics created within the apparatus 104 contribute to the rapid reaction times and high carbonation rates achieved in the CO₂ mineralization process.

FIG. 3 is a block diagram of a system for mineralization of carbon dioxide, in accordance with another embodiment of the present disclosure. FIG. 3 is described in conjunction with elements from FIGS. 1 and 2A to 2D. With reference to FIG. 3, there is shown a system 300 for mineralization of carbon dioxide. The system 300 illustrated in FIG. 3 expands upon a single-stage process of the system 100 shown in FIG. 1, incorporating more than one apparatus (for example, the apparatus 104) in series to enhance the overall efficiency and conversion rate of the CO₂ mineralization process. It should be noted that the system 300 incorporates and builds upon the elements and principles of the system 100 described in FIG. 1. Unless otherwise specified, components in the system 300 are similar in function and operation to their counterparts in the system 100, and the same reference numerals are used to denote corresponding elements.

The system 300 has a multi-stage configuration for more enhanced CO₂ mineralization. In the illustrated embodiment of FIG. 3, the system 300 includes three reactor stages including a first reactor stage 302A, a second reactor stage 302B, and a third reactor stage 302C. Each of the first reactor stage 302A, the second reactor stage 302B, and the third reactor stage 302C includes a specialized reactor like the apparatus 104 described in FIGS. 2A-2D. However, in some other embodiments, the system 300 may include any number of reactor stages, as per the application requirements without limiting the scope of the present disclosure.

The first reactor stage 302A receives the initial slurry from the mixing and preparation components via a first slurry pump 304A. After processing in a first apparatus 306A, a first carbonated slag output is collected in a first slurry tank 308A and then pumped to next stage i.e., the second reactor stage 302B via a second slurry pump 304B. In some implementations, the first slurry tank 308A allows for potential adjustments to composition and conditions of the first carbonated slag output before entering the second reactor stage 302B. After that, a second apparatus 306B of the second reactor stage 302B processes the first carbonated slag output received from the first reactor stage 302A, further advancing the carbonation reaction and generating a second carbonated slag output. The second carbonated slag output is collected in a second slurry tank 308B and pumped to the final stage, i.e., the third reactor stage 302C, via the third slurry pump 304C. Between each reactor stage, the slurry pumps facilitate the transfer of material, ensuring consistent flow through the system 300. Such inter-stage transfers also provide opportunities for sampling, analysis, or additional inputs if required. The third reactor stage 302C represents the final reactor in the series. The third reactor stage 302C also has a third apparatus 306C that gives a third carbonated slag output stored in a third slurry tank 308C. After the third reactor stage 302C, a highly carbonated slag output is generated that proceeds to separation and other post-processing steps, including filtration, centrifugation, washing, and drying.

In some implementations, the separation is performed by the separator 122 as discussed above in FIG. 1. In a similar way, the solvent blend devoid of carbon dioxide segregated by the separator 122 during the separation is released back into the CO₂-dissolving solution source 110. After the separation, the highly carbonated slag output is fed into a washer 310 for cleaning the highly carbonated slag output. Later, the washed highly carbonated slag output pass through the one or more dryers 124 to remove any excess moisture and then finally packed in the final product packaging unit 126.

Each reactor stage may also release a solvent blend devoid of CO₂ from the overflow outlet of each apparatus of the three reactor stages. The solvent blend devoid of CO₂ received from the first apparatus 306A is fed into the second reactor stage 302B and similarly, the solvent blend devoid of CO₂ received from the second apparatus 306B is fed into the third reactor stage 302C.

In some implementations, the system 300 further a fine particle filter 312 operably coupled with the overflow outlet of the third apparatus 306C, the CO₂-dissolving solution source 110, and the washer 310. The fine particle filter 312 is configured to purify the regenerated solvent blend by removing any suspended fine solid particles, which may be remnants of carbonated material, unreacted industrial alkali waste, or other process-introduced impurities. Such filtration step is essential for maintaining system efficiency by preventing potential clogging or fouling of equipment in subsequent cycles, particularly in heat exchangers, pumps, and the specialized reactors. By preserving the purity and effectiveness of the regenerated solvent blend, the fine particle filter 312 ensures that the regenerated solvent blend maintains its CO₂ absorption capacity without introducing contaminants into the next process cycle. Additionally, the fine particle filter 312 helps extend equipment life by reducing wear from circulating particles and contributes to maintaining final product quality by preventing the reintroduction of any carried-over fine particles of carbonated product.

The multi-stage configuration of the system 300 allows for progressive carbonation, potentially increasing the overall conversion rate and efficiency of the CO₂ mineralization process. Beneficially, the system 300 also offers flexibility in optimizing conditions at each stage to accommodate varying feedstock qualities or to target specific product characteristics.

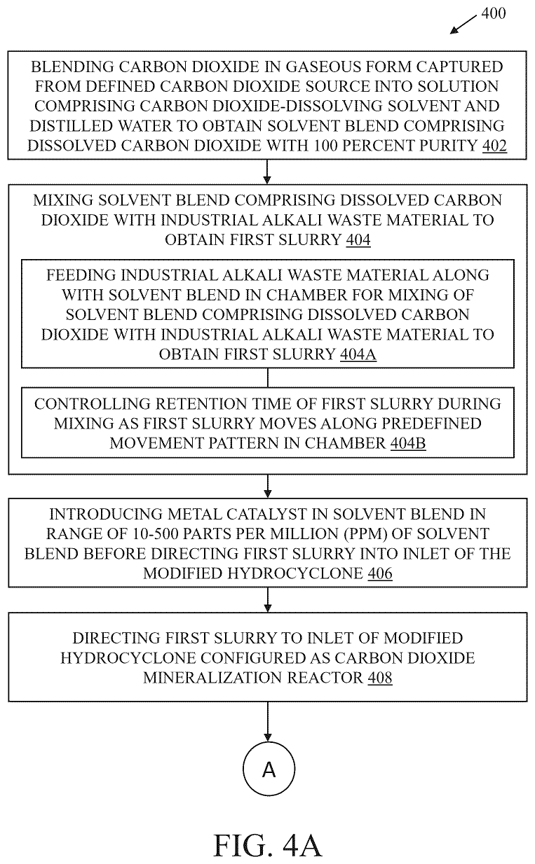

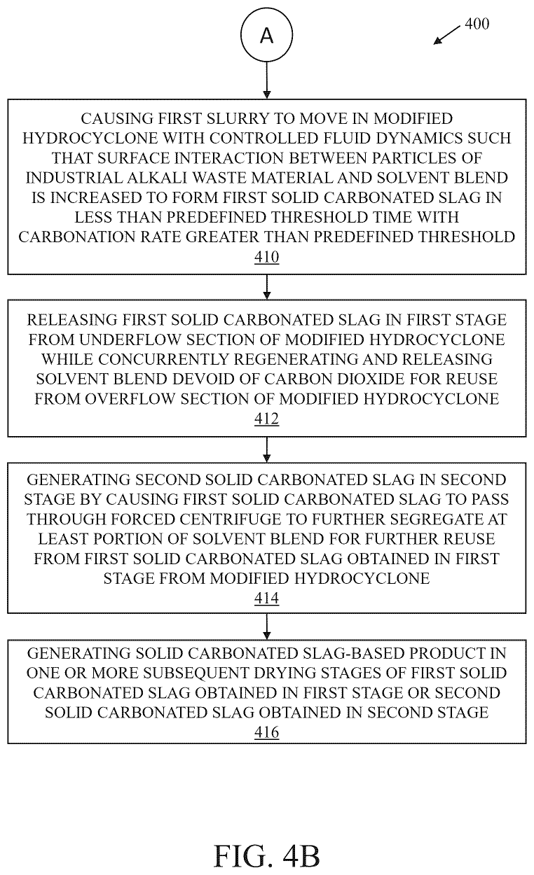

FIGS. 4A and 4B collectively is a flowchart of a method for mineralization of carbon dioxide, in accordance with an embodiment of the present disclosure. FIGS. 4A and 4B are described in conjunction with the elements from FIGS. 1, 2A to 2D, and 3. With reference to FIGS. 4A and 4B, there is shown a flowchart of a method 400 for mineralization of carbon dioxide. In an implementation, the method 400 is executed in the system 100 or 300. The method 400 may include steps 402 to 416.

At 402, the method 400 includes blending carbon dioxide in the gaseous form captured from a defined carbon dioxide source into a solution comprising a carbon dioxide-dissolving solvent and a distilled water to obtain the solvent blend comprising the dissolved carbon dioxide with 100 percent purity. The carbon dioxide source may include industrial emissions (for example; cement production, steel manufacturing, or chemical plants, emissions from power plants (for example; coal-fired or natural gas power plants) or other carbon-intensive processes (for example; oil refineries, petrochemical plants, or even large-scale fermentation processes). After capture, the carbon dioxide is compressed and cooled to remove impurities and stored in a pressurized form. For the mineralization process, carbon dioxide is converted back to the gas, likely by reducing pressure and/or increasing temperature.

The carbon dioxide-dissolving solvent is a chemical compound or mixture of compounds designed to efficiently absorb and temporarily hold carbon dioxide molecules in solution. The carbon dioxide-dissolving solvents are characterized by their high affinity for carbon dioxide and their ability to form reversible chemical bonds or complexes with the carbon dioxide molecules. In an example, carbon dioxide-dissolving solvent may be amine-based compounds such as monoethanolamide (MEA), diethanolamine (DEA), and methyl diethanolamine (MDEA), as well as other classes of compounds like amino acid salts or carbonate solutions. The choice of solvent may be optimized based on specific process requirements, energy efficiency considerations, and compatibility with the particular carbon dioxide source and mineralization reactions involved.

The combination of the carbon dioxide-dissolving solvent and distilled water provides precise control over solution chemistry, optimizing conditions for both the carbon dioxide absorption and subsequent mineralization reactions. The combination improves mass transfer kinetics, leading to faster absorption rates, while the water component aids in thermal management, maintaining stable operating temperatures. The distilled water ensures no impurities are introduced, maintaining high purity of the carbon dioxide. The carbon dioxide-dissolving solvent has reversible carbon dioxide binding, facilitating controlled release during mineralization. Moreover, this approach often allows for the carbon dioxide absorption at near-ambient conditions, potentially reducing energy costs compared to high-pressure or cryogenic methods

At 404, the method 400 includes mixing a solvent blend including dissolved carbon dioxide with the industrial alkali waste material to obtain the first slurry. The mixing occurs in a controlled environment, for example a specialized mixing chamber. The mixing process is carefully controlled to achieve a uniform dispersion of the solid waste particles within the liquid solvent blend, creating the first slurry. The resulting first slurry is a well-mixed suspension of partially reacted industrial alkali waste material in the carbon dioxide rich solvent, primed for further reaction in subsequent stages of the mineralization process.

At 404A, the method 400 further includes feeding the industrial alkali waste material in the heating chamber along with the solvent blend and the metal catalyst for the mixing of the solvent blend including the dissolved carbon dioxide with the industrial alkali waste material to obtain the first slurry. The metal catalyst accelerates the carbon mineralization reaction. The metal catalyst lowers the activation energy barrier, allowing the reaction to proceed more rapidly and potentially under milder conditions. The catalytic effect may significantly reduce processing time and energy requirements. The metal catalyst may also enhance the selectivity of the mineralization reaction, promoting the formation of desired carbonate products while minimizing unwanted side reactions. The selectivity leads to higher product purity and potentially reduces the need for downstream purification steps. When well-dispersed in the solvent blend, the metal catalyst ensures a more uniform reaction environment throughout the first slurry. The homogeneity promotes consistent mineralization across all particles of the alkali waste material, leading to more complete conversion and uniform product characteristics. The catalytic action also allows the mineralization process to occur at lower temperatures than would be possible without a catalyst.

At 404B, the method 400 further includes controlling a retention time of the first slurry in the heating chamber and a temperature in the heating chamber in a range of 25 to 120 degree Celsius during the mixing as the first slurry moves along a loop pathway configured in the heating chamber. The controlled environment of the heating chamber ensures optimal mixing and intimate contact between the dissolved carbon dioxide and alkali waste particles, improving mass transfer and reaction efficiency. The elevated temperature activates the metal catalyst, further speeding up the reaction by lowering activation energy. Uniform heat distribution in the chamber leads to consistent reaction conditions, resulting in more predictable and controllable mineralization outcomes. The formation of a homogeneous first slurry in this controlled setting is crucial for ensuring uniform reactions throughout the mixture. Additionally, the heating chamber allows for precise management of moisture content and potential pre-treatment of the alkali waste, both of which can significantly enhance reactivity. The combined heating and mixing approach improve energy efficiency compared to separate operations.

At 406, the method 400 further includes introducing the metal catalyst in the solvent blend in a range of 10-500 parts per million (ppm) of the solvent blend before directing the first slurry into the inlet of the modified hydrocyclone. The pre-mixing of the metal catalyst ensures it is fully integrated with the solvent blend before encountering the industrial alkali waste material, optimizing its effectiveness from the moment of contact. The introduction of the metal catalyst also facilitates easier catalyst recovery post-process, as it remains primarily associated with the liquid phase. Importantly, the low ppm range minimizes potential contamination of the final mineralized product, which is important for its subsequent use or disposal. Overall, the carefully controlled introduction of the metal catalyst enhances reaction kinetics, improves process efficiency, and contributes to the overall effectiveness of the carbon dioxide mineralization process in the modified hydrocyclone.

At 408, the method 400 further includes directing the first slurry to an inlet of a modified hydrocyclone configured as a carbon dioxide mineralization reactor. The sophisticated transfer system, utilizing carefully selected pumps, moves the first slurry through a network of pipes designed to prevent settling and separation. The piping system incorporates flow control devices, pressure management systems, and temperature control mechanisms to ensure optimal conditions are maintained. As the first slurry approaches the hydrocyclone, it is directed to a specially designed tangential inlet, engineered to create the necessary vortex flow for efficient mineralization. The entire process is designed for continuous operation, with buffer tanks ensuring a steady supply to the hydrocyclone. The carefully orchestrated directing process ensures that the first slurry enters the modified hydrocyclone under ideal conditions, setting the stage for effective utilization of the hydrocyclone's controlled fluid dynamics in the carbon dioxide mineralization reaction. The precise control overflow rate, pressure, and temperature, combined with the specialized inlet design, maximizes the efficiency of the mineralization process.

At 410, the method 400 includes causing the first slurry to move in the modified hydrocyclone with controlled fluid dynamics such that surface interaction between particles of the industrial alkali waste material and the solvent blend is increased to form a first solid carbonated slag in less than the predefined threshold time with a carbonation rate greater than the predefined threshold. In operation, the first slurry enters the modified hydrocyclone tangentially, creating a powerful vortex flow. The vortex generates two distinct flow patterns: an outer spiral moving downwards and an inner spiral moving upwards. The centrifugal forces created by this motion cause the heavier particles to move towards the walls while lighter particles and fluid remain in the center. The controlled fluid dynamic significantly increases the surface interaction between the industrial alkali waste particles and the carbon dioxide-rich solvent blend. The high shear forces and turbulence break down particle agglomerates, exposing fresh reactive surfaces. Simultaneously, the swirling motion ensures continuous contact between the reactive components, accelerating the mineral carbonation process.

In an example, the first slurry containing steel slag particles in the solvent blend including dissolved carbon dioxide. As the first slurry enters the apparatus 104, the slag particles are subjected to intense centrifugal forces. A 100-micron slag particle may experience forces several thousand times that of gravity, causing it to rapidly move outward. The outward motion not only increases contact with the solvent blend comprising dissolved carbon dioxide but also potentially causes micro-fractures in the particle, exposing new reactive surfaces. Concurrently, solvent blend comprising dissolved carbon dioxide is constantly brought into contact with these freshly exposed surfaces, driving the carbonation process forward at an accelerated rate. Advantageously, the high-shear environment significantly accelerates the carbonation process. The constant mixing ensures optimal contact between reactants. The vortex flow utilizes the entire reactor space effectively. The design allows for non-stop operation, improving overall efficiency. The swirling motion helps prevent fouling and scaling on reactor walls. The process may be easily scaled up or down by adjusting dimensions of the apparatus 104. The design leverages fluid dynamics to enhance mixing, potentially reducing energy requirements compared to traditional stirred reactors.

In an implementation, the predefined threshold time is in the range of 1-15 minutes and the predefined threshold of the carbonation rate is in the range of 50-99 percent based on the predefined threshold time. The ability to achieve high carbonation rates of 50-99% within 1-15 minutes dramatically increases throughput, potentially boosting daily production capacity by up to 96 times compared to conventional methods. The shortened reaction time allows for smaller reactor volumes, reducing capital costs and plant footprint substantially. Energy efficiency is greatly enhanced, with potential savings of 80% or more due to reduced time for maintaining reaction conditions. The high carbonation rates enable more effective carbon dioxide sequestration, making the method 400 viable for large-scale carbon capture projects. Operating costs are significantly lowered through reduced labor, utility consumption, and equipment wear. The rapid processing allows for flexible feedstock management and more responsive process control, leading to better product consistency. Faster primary reactions minimize unwanted side reactions, potentially improving product purity and simplifying downstream processing. Additionally, the efficient process aligns with green chemistry principles, optimizing raw material use and minimizing waste generation. The combined advantages position this rapid carbon dioxide mineralization process as a transformative technology in carbon capture and utilization, offering both economic and environmental benefits.

At 412, the method 400 includes releasing the first solid carbonated slag in a first stage from an underflow section of the modified hydrocyclone while concurrently regenerating and releasing the solvent blend devoid of carbon dioxide for reuse from an overflow section of the modified hydrocyclone. The dual-action approach leverages the controlled fluid dynamics of a hydrocyclone to perform separation, product collection, and solvent regeneration in a single, continuous operation. As the carbonated slurry enters the hydrocyclone tangentially at high velocity, it forms a powerful vortex. The vortex generates strong centrifugal forces, which are key to the separation process. The heavier carbonated slag particles, typically ranging from 30 to 180 microns in size with a density of about 2.9 g/cm³, are forced towards the walls of the hydrocyclone. The heavier carbonated slag particles then spiral downwards at speeds of 0.5-1 m/s, eventually exiting through the underflow opening at the bottom of the hydrocyclone. The underflow stream consists of a concentrated slurry, often with 60-70% solids content by weight, representing the carbonated product with carbonation rates typically between 85-95%. Concurrently, the lighter, carbon dioxide depleted solvent moves towards the center of the hydrocyclone and spirals upwards at 2-3 m/s in the central core. As the depleted solvent moves upwards, it experiences a significant pressure drop, often from several bars at the inlet to near atmospheric pressure at the overflow. The pressure reduction causes the release of any residual dissolved carbon dioxide from the solvent, effectively regenerating it for reuse. The now-regenerated solvent exits through the overflow at the top of the hydrocyclone, with its carbon dioxide content typically reduced from about 0.45 to 0.05 moles carbon dioxide per mole of solvent.

Advantageously, high carbonation rates are achieved in a single pass, processes large volumes continuously, and combines multiple operations in a compact design. The integration of product separation and solvent regeneration into one step significantly enhances energy efficiency and reduces the overall footprint of the carbon dioxide mineralization process. Moreover, the continuous nature of the operation allows for high throughput, making it particularly suitable for industrial-scale carbon capture and utilization projects.

At 414, the method 400 includes generating the second solid carbonated slag in the second stage by causing the first solid carbonated slag to pass through a forced centrifuge to further segregate at least a portion of the solvent blend for further reuse from the first solid carbonated slag obtained in the first stage from the modified hydrocyclone. By subjecting the first solid carbonated slag to centrifugal forces, the method 400 achieves a more thorough separation of residual solvent from the solid material. The separation results in a drier, more concentrated carbonated product, which is often desirable for subsequent applications or further processing. The additional solvent recovery increases the overall efficiency of the solvent utilization, reducing operational costs and minimizing waste. The centrifugation process may also improve the purity of the carbonated slag by removing fine impurities that may have remained after the hydrocyclone stage. The higher purity can enhance the value and versatility of the final product. Furthermore, the forced centrifuge may be optimized to control the particle size distribution of the slag, potentially tailoring it for specific end-use requirements. The process also allows for better control over the moisture content of the final product, which is important for many applications, particularly in construction materials. From an operational perspective, the second stage acts as a safeguard, ensuring consistent product quality even if there are variations in the performance of the first stage hydrocyclone. Additionally, the recovered solvent from the second stage may be immediately recycled back into the process, contributing to a more closed-loop, sustainable operation. Overall, the second stage significantly enhances the product quality, process efficiency, and economic viability of the carbon dioxide mineralization process.

At 416, the method 400 further includes generating the solid carbonated slag-based product in one or more subsequent drying stages of the first solid carbonated slag obtained in the first stage or the second solid carbonated slag obtained in the second stage. The controlled drying allows precise management of moisture content, important for various industrial applications, particularly in construction and materials sectors. The drying process may promote further carbonation processes, potentially increasing overall carbon dioxide sequestration. The drying process also enables the production of materials with tailored physical properties such as specific particle size distributions, porosity, and surface area, expanding the range of potential applications. The controlled environment during drying helps preserves the stability of carbonated minerals, ensuring long-term carbon dioxide sequestration effectiveness. Economically, dried products often command higher market values compared to wet slurries, potentially improving the financial viability of the entire carbon dioxide mineralization process.

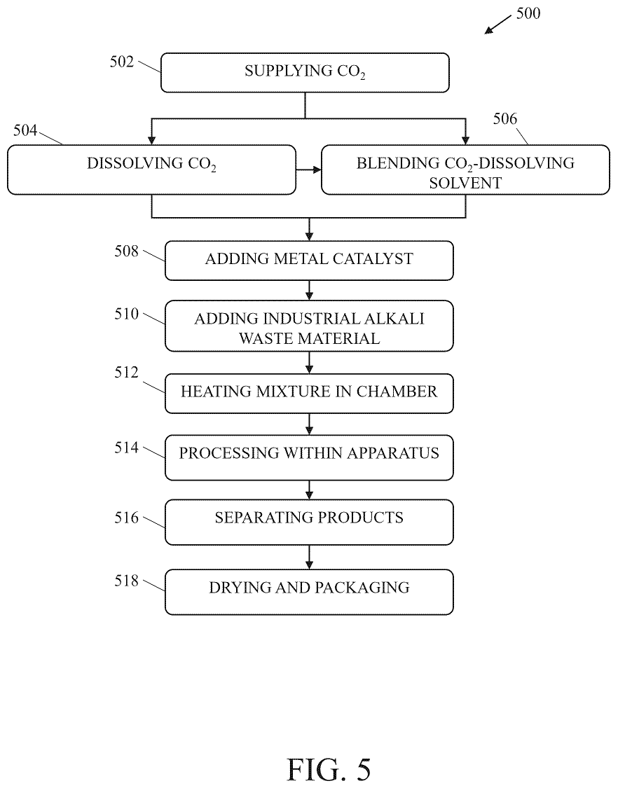

FIG. 5 is a diagram illustrating exemplary operations for mineralization of carbon dioxide, in accordance with an embodiment of the present disclosure. FIG. 5 is described in conjunction with elements from FIGS. 1, 2A-2D, 3, and 4. With reference to FIG. 5, there is shown a flowchart 500 illustrating exemplary operations 502 to 518. for mineralization of carbon dioxide with industry alkali waste material.

At operation 502, carbon dioxide is supplied from the defined carbon dioxide source 108. The carbon dioxide may be captured from sources such as steel plants, cement plants, chemical plants, or power generation plants. The supplied carbon dioxide may be either pure or in a mixture form (i.e., mixed with other gases). After that, at operation 504, the supplied carbon dioxide is dissolved in the carbon dioxide-dissolving solvent of the solution from the CO₂-dissolving solution source 110. The carbon dioxide loading in the solvent ranges from 0.001 moles to 0.6 moles of carbon dioxide per mole of carbon dioxide-dissolving solvent. Then, at operation 506, the carbon dioxide-dissolving solvent is blended with distilled water to form the solution. The blend ratio may range from 1% solvent and 99% water to 99% solvent and 1% water.

Further, at operation 508, a metal catalyst from the metal catalyst source 114 is added to the solvent blend. Furthermore, at operation 510, the industrial alkali waste material from the industrial alkali waste material source 112 is added to the solvent blend containing dissolved carbon dioxide and the metal catalyst. After that, at operation 512, the mixture of the solvent blend, the metal catalyst, and the industrial alkali waste material is sent to the chamber 102. In some embodiments, the chamber 102 functions as a heating chamber, configured to heat the mixture up to a predetermined temperature. Later, at operation 514, the heated mixture, now forming the first slurry, is then directed to the apparatus 104, which functions as the carbon dioxide mineralization reactor for the mineral carbonation process. Within the apparatus 104, the first slurry undergoes the mineral carbonation process. The controlled fluid dynamics within the apparatus 104 facilitate rapid carbonation, resulting in the formation of solid carbonated slag. The apparatus 104 simultaneously separates the solid carbonated slag from the regenerated solvent blend. Then, at operation 516, the regenerated solvent blend is recycled back to the CO₂-dissolving solution source 110. The solid carbonated slag is then sent to the separator 122 to separate any remaining liquid from the solids. Lastly, at operation 518, the solid carbonated slag is sent to the dryer 124 to completely remove any residual moisture. The dried solid carbonated slag is then packaged as the final product in the final product packaging unit 126.

In an exemplary implementation, the CO₂ loading (e.g., in the carbon dioxide-dissolving solvent) may be controlled to lie in the range of 10 to 99%. Further, depending on the CO₂ loading, the extent of carbonation (i.e., the carbonation rate) in the first carbonated slag may be controlled within the range of 10-99%, i.e., to be partial or full carbonation, depending on the end-use. In other words, the carbonation rate of the first solid carbonated slag may be controllable within the range of 10-99% by controlling at least the CO₂ loading, and other operations of the disclosed method. For example, in some cement applications, a lower carbonation rate of 10-30% may be useful as it allows for better control of setting time and strength development in the final concrete product. In another example, when the primary goal is to maximize CO₂ capture and storage, a high carbonation rate of 80-99% ensures that the maximum amount of CO₂ is converted into stable carbonate minerals. In yet another example, for applications requiring pure carbonate products (e.g., in the pharmaceutical or food industries), a high carbonation rate of 80-99% helps ensure complete conversion of the alkali materials into the desired carbonate forms (e.g., high-purity calcium or magnesium carbonates), minimizing impurities. The disclosed method provides flexibility to control the CO₂ loading as well as the carbonation rate of the first solid carbonated slag depending on applications.

In an implementation, after the initial carbonation reaction in the modified hydrocyclone, the resulting slurry of carbonated slag may be further directed to a series of separation units, such as selective precipitation tanks or ion exchange columns. By controlling pH, temperature, and other reaction conditions, calcium carbonate and magnesium carbonate may be precipitated separately. These precipitates could then be filtered, washed, and dried to obtain high-purity calcium carbonate and magnesium carbonate products.

### EXAMPLES OF PREPARATION

### Example 1

In one exemplary embodiment, for every 1 kg of point-sourced CO₂ introduced into the system 100 or 300, 2.5 to 3.5 kg of slag, depending on its composition, was added. The slag used was an industrial alkali waste selected from a steel blast furnace slag, cement kiln dust, or fly ash. Additionally, 2 kg of amine and 8 kg of water were provided. This combination resulted in the production of 3.5 to 4.5 kg of carbonated slag as a final product. The carbonated slag was then blended with cement in amounts ranging from 5% to 50% by weight. The resulting green concrete provided permanent storage for the sequestered CO₂. In total, 1 kg of CO₂ was directly removed from the system 100 or 300, while the total CO₂ reduction achieved, including permanent storage, ranged from 4.5 to 5.5 kg.

### Example 2

In another exemplary embodiment, a flue gas stream containing 10% CO₂ was utilized. To capture 1 kg of CO₂ from the flue gas, 10 kg of flue gas was processed. Additionally, 2.5 to 3.5 kg of slag, depending on its composition, 2 kg of amine, and 8 kg of water were required. The slag used was an industrial alkali waste selected from a steel blast furnace slag, cement kiln dust, or fly ash. This resulted in the production of 3.5 to 4.5 kg of carbonated slag. The approach effectively reduced the cost of CO₂ capture by utilizing the flue gas stream, rather than directly capturing pure CO₂, for reacting with slag to form the carbonated slag product.

### Example 3

In one exemplary embodiment, for the mineralization of 1 ton of point-sourced CO₂, approximately 2.5 to 3.5 tons of slag (depending on its composition) was required, along with 2 tons of amine and 8 tons of water. The slag used was an industrial alkali waste selected from a steel blast furnace slag, cement kiln dust, or fly ash. This process resulted in the production of 3.5 to 4.5 tons of carbonated slag, which serves as the final product. The carbonated slag can be blended into cement at a proportion ranging from 5% to 50% by weight. This blended green concrete provides a means for the permanent storage of CO₂.

### Example 4

In another exemplary embodiment, when utilizing a flue gas stream containing 10% CO₂, 1 ton of CO₂ was extracted from approximately 10 tons of flue gas. To mineralize this 1 ton of CO₂, around 2.5 to 3.5 tons of slag (depending on its composition), 2 tons of amine, and 8 tons of water were required. The slag used was an industrial alkali waste selected from a steel blast furnace slag, cement kiln dust, or fly ash. This process produced 3.5 to 4.5 tons of carbonated slag as the final product.

### Experimental Part

### Experiment 1

In an experimental setup, mono ethanol amine (MEA) was used as a solvent with varying CO₂ loadings to react with steel blast furnace slag containing different percentages of calcium oxide. Tables 1, 2, and 3 present the results for slags with 50%, 40%, and 30% calcium oxide content respectively as provided below.

TABLE 1
MEA as a solvent with different CO₂ loading with a steel blast furnace slag which has 50% calcium oxide.

| | | | MEA | | | | | | | | | |
|---|---|---|---|---|---|---|---|---|---|---|---|---|
| CO₂ | MEA | 20 g | weight | Water | CO₂ | CO₂ | CaCO₃ | CaO | CaO | Slag | CaCO₃ | Carbonated |
| (moles) | (Moles) | MEA | (g) | (g) | (moles) | (g) | (MW) | (MW) | (g) | (50% CaO) | (g) | slag (g) |
| 0.40 | 1.00 | 0.33 | 20.00 | 80.00 | 0.13 | 5.77 | 100.00 | 56.00 | 7.34 | 14.69 | 13.11 | 20.46 |
| 0.50 | 1.00 | 0.33 | 20.00 | 80.00 | 0.16 | 7.21 | 100.00 | 56.00 | 9.18 | 18.36 | 16.39 | 25.57 |
| 0.60 | 1.00 | 0.33 | 20.00 | 80.00 | 0.20 | 8.66 | 100.00 | 56.00 | 11.02 | 22.03 | 19.67 | 30.69 |

TABLE 2
MEA as a solvent with different CO₂ loading with a steel blast furnace slag which has 40% calcium oxide.

| | | | MEA | | | | | | | | | |
|---|---|---|---|---|---|---|---|---|---|---|---|---|
| CO₂ | MEA | 20 g | weight | Water | CO₂ | CO₂ | CaCO₃ | CaO | CaO | Slag | CaCO₃ | Carbonated |
| (moles) | (Moles) | MEA | (g) | (g) | (moles) | (g) | (MW) | (MW) | (g) | (40% CaO) | (g) | slag (g) |
| 0.40 | 1.00 | 0.33 | 20.00 | 80.00 | 0.13 | 5.77 | 100.00 | 56.00 | 7.34 | 18.36 | 13.11 | 24.13 |
| 0.50 | 1.00 | 0.33 | 20.00 | 80.00 | 0.16 | 7.21 | 100.00 | 56.00 | 9.18 | 22.95 | 16.39 | 30.16 |
| 0.60 | 1.00 | 0.33 | 20.00 | 80.00 | 0.20 | 8.66 | 100.00 | 56.00 | 11.02 | 27.54 | 19.67 | 36.20 |

TABLE 3
MEA as a solvent with different CO₂ loading with a steel blast furnace slag which has 30% calcium oxide

| | | g moles | MEA | | | | | | | | | |
|---|---|---|---|---|---|---|---|---|---|---|---|---|
| CO₂ | MEA | of 20 g | weight | Water | CO₂ | CO₂ | CaCO₃ | CaO | CaO | Slag | CaCO₃ | Carbonated |
| (moles) | (Moles) | MEA | (g) | (g) | (moles) | (g) | (MW) | (MW) | (g) | (30% CaO) | (g) | slag (g) |
| 0.40 | 1.00 | 0.33 | 20.00 | 80.00 | 0.13 | 5.77 | 100.00 | 56.00 | 7.34 | 24.48 | 13.11 | 30.25 |
| 0.50 | 1.00 | 0.33 | 20.00 | 80.00 | 0.16 | 7.21 | 100.00 | 56.00 | 9.18 | 30.60 | 16.39 | 37.81 |
| 0.60 | 1.00 | 0.33 | 20.00 | 80.00 | 0.20 | 8.66 | 100.00 | 56.00 | 11.02 | 36.72 | 19.67 | 45.38 |

The tables 1, 2, and 3 demonstrate the impact of calcium oxide content in the slag on the carbonation process and product yield. The data shows that as the calcium oxide content in the slag decreases from 50% (Table 1) to 40% (Table 2) and 30% (Table 3), there is a notable change in the carbonation outcomes. With higher calcium oxide content (Table 1), less slag is required to react with the same amount of CO₂, resulting in a more efficient conversion. As the calcium oxide percentage decreases (Tables 2 and 3), more slag is needed to react with the same quantity of CO₂, leading to a larger overall mass of carbonated slag produced. This is evident from the increasing values in the “Carbonated slag” column across the three tables for the same CO₂ input. The CO₂ loading in the MEA solvent, varying from 0.40 to 0.60 moles in each table, also affects the carbonation process, with higher loadings generally resulting in more carbonated slag production. These results, as presented in the tables, highlight an ability to adapt to varying feedstock qualities, which is an important factor for practical industrial applications where waste material composition may fluctuate.

### Experiment 2

In another experimental setup, Methyl Di-ethanol amine (MDEA) was used as a solvent with varying CO₂ loadings to react with steel blast furnace slag containing different percentages of calcium oxide. Tables 4, 5, and 6 present the results for slags with 50%, 40%, and 30% calcium oxide content respectively, as provided below.

TABLE 4
MDEA as a solvent with different CO₂ loading with a steel blast furnace slag which has 50% calcium oxide.

| | | | MDEA | | | | | | | | | |
|---|---|---|---|---|---|---|---|---|---|---|---|---|
| CO₂ | MDEA | 20 g | weight | Water | CO₂ | CO₂ | CaCO₃ | CaO | CaO | Slag | CaCO₃ | Carbonated |
| (moles) | (Moles) | MEA | (g) | (g) | (moles) | (g) | (MW) | (MW) | (g) | (50% CaO) | (g) | slag (g) |
| 0.40 | 1.00 | 0.17 | 20.00 | 80.00 | 0.07 | 2.95 | 100.00 | 56.00 | 3.76 | 7.52 | 6.71 | 10.47 |
| 0.50 | 1.00 | 0.17 | 20.00 | 80.00 | 0.08 | 3.69 | 100.00 | 56.00 | 4.70 | 9.40 | 8.39 | 13.09 |
| 1.00 | 1.00 | 0.17 | 20.00 | 80.00 | 0.17 | 7.38 | 100.00 | 56.00 | 9.40 | 18.80 | 16.78 | 26.18 |

TABLE 5
MDEA as a solvent with different CO₂ loading with a steel blast furnace slag which has 40% calcium oxide.

| | | | MDEA | | | | | | | | | |
|---|---|---|---|---|---|---|---|---|---|---|---|---|
| CO₂ | MDEA | 20 g | weight | Water | CO₂ | CO₂ | CaCO₃ | CaO | CaO | Slag | CaCO₃ | Carbonated |
| (moles) | (Moles) | MEA | (g) | (g) | (moles) | (g) | (MW) | (MW) | (g) | (40% CaO) | (g) | slag (g) |
| 0.40 | 1.00 | 0.17 | 20.00 | 80.00 | 0.07 | 2.95 | 100.00 | 56.00 | 3.76 | 9.40 | 6.71 | 12.35 |
| 0.50 | 1.00 | 0.17 | 20.00 | 80.00 | 0.08 | 3.69 | 100.00 | 56.00 | 4.70 | 11.75 | 8.39 | 15.44 |
| 1.00 | 1.00 | 0.17 | 20.00 | 80.00 | 0.17 | 7.38 | 100.00 | 56.00 | 9.40 | 23.50 | 16.78 | 30.88 |

TABLE 6
MDEA as a solvent with different CO₂ loading with a steel blast furnace slag which has 30% calcium oxide

| | | g moles | MDEA | | | | | | | | | |
|---|---|---|---|---|---|---|---|---|---|---|---|---|
| CO₂ | MDEA | of 20 g | weight | Water | CO₂ | CO₂ | CaCO₃ | CaO | CaO | Slag | CaCO₃ | Carbonated |
| (moles) | (Moles) | MEA | (g) | (g) | (moles) | (g) | (MW) | (MW) | (g) | (30% CaO) | (g) | slag (g) |
| 0.40 | 1.00 | 0.17 | 20.00 | 80.00 | 0.07 | 2.95 | 100.00 | 56.00 | 3.76 | 12.53 | 6.71 | 15.49 |
| 0.50 | 1.00 | 0.17 | 20.00 | 80.00 | 0.08 | 3.69 | 100.00 | 56.00 | 4.70 | 15.66 | 8.39 | 19.36 |
| 1.00 | 1.00 | 0.17 | 20.00 | 80.00 | 0.17 | 7.38 | 100.00 | 56.00 | 9.40 | 31.33 | 16.78 | 38.71 |

The data demonstrates the impact of calcium oxide content in the slag on the carbonation process and product yield when using MDEA as a solvent. As observed with the MEA solvent, the calcium oxide percentage in the slag significantly influences the carbonation efficiency and the amount of carbonated slag produced.

Table 4 shows that with 50% calcium oxide content, less slag is required to react with the same amount of CO₂, resulting in a more efficient conversion. As the calcium oxide percentage decreases to 40% (Table 5) and 30% (Table 6), more slag is needed to react with the same quantity of CO₂, leading to a larger overall mass of carbonated slag produced. This trend is evident from the increasing values in the “Carbonated slag” column across the three tables for the same CO₂ input.

The CO₂ loading in the MDEA solvent, varying from 0.40 to 1.00 moles in each table, shows a significant impact on the carbonation process. The higher CO₂ loading capacity of MDEA (up to 1 mole of CO₂ per mole of MDEA) allows for more efficient CO₂ utilization, particularly at higher loadings. This is reflected in the substantial increase in carbonated slag production when CO₂ loading increases from 0.50 to 1.00 moles across all slag types.

These results highlight an adaptability to different solvents and varying feedstock qualities. The use of MDEA, with its higher CO₂ loading capacity, demonstrates the potential for enhanced CO₂ utilization in the mineralization process, particularly when dealing with industrial alkali waste materials of varying calcium oxide content

### Experiment 3

An extensive experimental study was conducted to evaluate the effect of apparatus dimensions on the carbonation rate and process time in the CO₂ mineralization reactor. Multiple apparatuses were fabricated with dimensions both within and outside the preferred ranges specified in the invention, while maintaining identical input materials and operating conditions. The overflow section diameter Dc was kept constant at 0.5 m for all experiments to ensure comparability.

### Methodology:

1. Input material: Steel slag with 40% CaO content, particle size 50-150 microns
2. Solvent: 30% monoethanolamine (MEA) solution
3. CO₂ concentration: 15% in feed gas
4. Operating temperature: 50° C.
5. Operating pressure: 5 bar
6. Slurry concentration: 20% solids by weight

### Results:

1. Width Bc of inlet:
   Within range (Dc/4=0.125 m): Achieved 95% carbonation in 3 minutes
   Outside range (Dc/2=0.25 m): Only reached 60% carbonation in 20 minutes
2. Diameter De of vortex finder:
   Within range (Dc/2=0.25 m): Completed 98% carbonation in 2.5 minutes
   Outside range (Dc/1.5=0.33 m): Only achieved 55% carbonation in 18 minutes
3. Height Hc of cylindrical portion of overflow section:
   Within range (Dc/2=0.25 m): Reached 97% carbonation in 3.5 minutes
   Outside range (Dc=0.5 m): Only achieved 50% carbonation in 22 minutes
4. Diameter Jc of underflow outlet:
   Within range (Dc/4=0.125 m): Achieved 96% carbonation in 4 minutes
   Outside range (Dc/2=0.25 m): Only reached 58% carbonation in 19 minutes
5. Spigot diameter Sc:
   Within range (Dc/8=0.0625 m): Completed 94% carbonation in 4.5 minutes
   Outside range (Dc/4=0.125 m): Only achieved 52% carbonation in 21 minutes
6. Length Lc of overflow section:
   Within range (Dc=0.5 m): Reached 95% carbonation in 3 minutes
   Outside range (3Dc=1.5 m): Only achieved 57% carbonation in 20 minutes
7. Length Zc of cone section:
   Within range (4Dc=2 m): Completed 96% carbonation in 3.5 minutes
   Outside range (2Dc=1 m): Only reached 54% carbonation in 23 minutes

### Analysis:

The experimental results consistently demonstrated that apparatus dimensions within the specified ranges led to significantly higher carbonation rates and reduced process times. All tests with dimensions within the preferred ranges achieved over 90% carbonation in less than 5 minutes. In contrast, dimensions outside these ranges often resulted in process times exceeding 15 minutes and substantially lower carbonation rates, typically below 60%.

These findings, as clearly illustrated in Table 7, underscore the critical importance of adhering to the dimensional specifications outlined in the present disclosure for optimal performance of the CO₂ mineralization process. The stark contrast in performance between apparatuses with dimensions within and outside the preferred ranges highlights the innovative nature of this design and its potential for significantly enhancing the efficiency of industrial-scale carbon capture and utilization processes.

TABLE 7
Comparative Performance of CO₂ Mineralization Apparatus
Dimensions: Within vs. Outside Preferred Ranges

| | Preferred | Within Range | Outside Range | Outside Range |
|---|---|---|---|---|
| Dimension | Range | Performance | Diameter | Performance |
| Diameter Dc of | 0.08 m to 1.2 m | Not directly compared | Dc = 0.5 m | Not directly |
| overflow section | | | | compared |
| Width Bc of inlet | Dc/3 to Dc/6 | 95% carbonation in | Dc/2 = 0.25 m | 60% carbonation |
| | (preferred Dc/4) | 3 minutes (at Dc/4 = | | in 20 minutes |
| | | 0.125 m) | | |
| Diameter De of | Dc/2 to Dc/4 | 98% carbonation in | Dc/1.5 = 0.33 m | 55% carbonation |
| vortex finder | (most preferred | 2.5 minutes (at Dc/2 = | | in 18 minutes |
| | Dc/2) | 0.25 m) | | |
| Height Hc of | Dc/2 to Dc/4 | 97% carbonation in | Dc = 0.5 m | 50% carbonation |
| cylindrical | (preferred Dc/2) | 3.5 minutes (at Dc/2 = | | in 22 minutes |
| portion of | | 0.25 m) | | |
| overflow section | | | | |
| Diameter Jc of | Dc/3 to Dc/5 | 96% carbonation in | Dc/2 = 0.25 m | 58% carbonation |
| underflow outlet | | 4 minutes (at Dc/4 = | | in 19 minutes |
| | | 0.125 m) | | |
| Spigot diameter | Dc/6 to Dc/10 | 94% carbonation in | Dc/4 = 0.125 m | 52% carbonation |
| Sc | | 4.5 minutes (at Dc/8 = | | in 21 minutes |
| | | 0.0625 m) | | |
| Length Lc of | Dc or 2Dc | 95% carbonation in | 3Dc = 1.5 m | 57% carbonation |
| overflow section | | 3 minutes (at Dc = | | in 20 minutes |
| | | 0.5 m) | | |
| Length Zc of cone | 3Dc to 5Dc | 96% carbonation in | 2Dc = 1 m | 54% carbonation |
| section | | 3.5 minutes (at 4Dc = | | in 23 minutes |
| | | 2 m) | | |

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments and/or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the present disclosure, which are, for brevity, described in the context of a single embodiment, may also be provided separately or in any suitable combination or as suitable in any other described embodiment of the disclosure.

What is claimed is:

1. A method for mineralization of carbon dioxide, comprising:
mixing a solvent blend comprising dissolved carbon dioxide with an industrial alkali waste material to obtain a first slurry;
directing the first slurry to an inlet of a modified hydrocyclone configured as a carbon dioxide mineralization reactor;
causing the first slurry to move in the modified hydrocyclone with controlled fluid dynamics such that surface interaction between particles of the industrial alkali waste material and the solvent blend is increased to form a first solid carbonated slag in less than a predefined threshold time with a carbonation rate greater than a predefined threshold; and
releasing the first solid carbonated slag in a first stage from an underflow section of the modified hydrocyclone while concurrently regenerating and releasing the solvent blend devoid of carbon dioxide for reuse from an overflow section of the modified hydrocyclone.

2. The method according to claim 1, further comprising blending carbon dioxide in a gaseous form captured from a defined carbon dioxide source into a solution comprising a carbon dioxide-dissolving solvent and a distilled water to obtain the solvent blend comprising the dissolved carbon dioxide with 100 percent purity.

3. The method according to claim 1, further comprising introducing a metal catalyst in the solvent blend in a range of 10-500 parts per million (ppm) of the solvent blend before directing the first slurry into the inlet of the modified hydrocyclone.

4. The method according to claim 3, further comprising:
feeding the industrial alkali waste material in a heating chamber along with the solvent blend and the metal catalyst for the mixing of the solvent blend comprising the dissolved carbon dioxide with the industrial alkali waste material to obtain the first slurry; and
controlling a retention time of the first slurry in the heating chamber and a temperature in the heating chamber in a range of 25 to 120 degree Celsius during the mixing as the first slurry moves along a loop pathway configured in the heating chamber.

5. The method according to claim 1, further comprising:
feeding the industrial alkali waste material along with the solvent blend in a chamber for the mixing of the solvent blend comprising the dissolved carbon dioxide with the industrial alkali waste material to obtain the first slurry; and
controlling a retention time of the first slurry during the mixing as the first slurry moves along a predefined movement pattern in the chamber;
wherein an amount of the industrial alkali waste material fed into the chamber is in a range of 0.1 to 10 times the weight of a carbon dioxide-dissolving solvent of the solvent blend.

6. The method according to claim 1, further comprising generating a second solid carbonated slag in a second stage by causing the first solid carbonated slag to pass through a forced centrifuge to further segregate at least a portion of the solvent blend for further reuse from the first solid carbonated slag obtained in the first stage from the modified hydrocyclone.

7. The method according to claim 6, further comprising generating a solid carbonated slag-based product in one or more subsequent drying stages of the first solid carbonated slag obtained in the first stage or the second solid carbonated slag obtained in the second stage.

8. The method according to claim 1, wherein the predefined threshold time is in a range of 1-15 minutes and the predefined threshold of the carbonation rate is in a range of 50-99 percent based on the predefined threshold time.

9. A system for mineralization of carbon dioxide, comprising:
a chamber configured to mix a solvent blend comprising dissolved carbon dioxide with an industrial alkali waste material to obtain a first slurry;
an apparatus configured as a carbon dioxide mineralization reactor, wherein the apparatus is configured to:
receive the first slurry via an inlet of the apparatus;
cause the first slurry to move within the apparatus with controlled fluid dynamics such that surface interaction between particles of the industrial alkali waste material and the solvent blend is increased to form a first solid carbonated slag in less than a predefined threshold time with a carbonation rate greater than a predefined threshold; and
release the first solid carbonated slag in a first stage from an underflow section of the apparatus while concurrently regenerating and releasing the solvent blend devoid of carbon dioxide for reuse from an overflow section of the apparatus.

10. The system according to claim 9, wherein the apparatus is a modified hydrocyclone configured as the carbon dioxide mineralization reactor.

11. The system according to claim 9, further comprising a mixer configured to blend carbon dioxide in a gaseous form captured from a defined carbon dioxide source into a solution comprising a carbon dioxide-dissolving solvent and a distilled water to obtain the solvent blend comprising the dissolved carbon dioxide.

12. The system according to claim 9, further comprising a controller configured to control introduction of a metal catalyst in the solvent blend in a range of 10-500 parts per million (ppm) of the solvent blend before directing the first slurry into the inlet of the apparatus configured as the carbon dioxide mineralization reactor.

13. The system according to claim 12, wherein the chamber is a heating chamber configured to receive the industrial alkali waste material along with the solvent blend and the metal catalyst for the mixing of the solvent blend comprising the dissolved carbon dioxide with the industrial alkali waste material to obtain the first slurry,
wherein the controller is further configured to control a retention time of the first slurry in the heating chamber and a temperature in the heating chamber in a range of 25 to 120 degree Celsius during the mixing as the first slurry moves along a loop pathway configured in the heating chamber.

14. The system according to claim 13, wherein an amount of the industrial alkali waste material fed into the chamber is in a range of 0.1 to 10 times the weight of a carbon dioxide-dissolving solvent of the solvent blend.

15. The system according to claim 9, further comprising a separator configured to generate a second solid carbonated slag in a second stage by causing the first solid carbonated slag to pass through a forced centrifugal force in the separator to further segregate at least a portion of the solvent blend for further reuse from the first solid carbonated slag obtained in the first stage from the apparatus.

16. The system according to claim 15, further comprising one or more dryers configured to generate a solid carbonated slag-based product in one or more subsequent drying stages of the first solid carbonated slag obtained in the first stage or the second solid carbonated slag obtained in the second stage.

17. The system according to claim 9, wherein the overflow section of the apparatus configured as the carbon dioxide mineralization reactor has a diameter in a range of 0.08 meter to 1.2 meter.

18. The system according to claim 17, wherein the inlet of the apparatus has a width in a range of one-third to one-sixth of the diameter of the overflow section.

19. The system according to claim 17, wherein a diameter of a vortex finder or an overflow outlet of the apparatus is in a range of one-half to one-quarter of the diameter of the overflow section.

20. The system according to claim 17, wherein a length of the inlet of the apparatus is in a range of one-half to one-quarter of the diameter of the overflow section.

21. The system according to claim 17, wherein a diameter of an underflow outlet of the underflow section of the apparatus is in a range of one-third to one-fifth of the diameter of the overflow section.

22. The system according to claim 17, wherein a spigot diameter of the apparatus is in a range of one-sixth to one-tenth of the diameter of the overflow section.

23. The system according to claim 17, wherein a length of the overflow section representing a cylindrical body of the apparatus is one of: either equal to the overflow section or twice the diameter of the overflow section.

24. The system according to claim 17, wherein a length of a cone section of the apparatus is in a range of three times to five times of the diameter of the overflow section.

25. An apparatus for mineralization of carbon dioxide, comprising:
a plurality of different sections that comprise an overflow section, an underflow section, a vortex finder positioned within the overflow section, and a cone section; and
an inlet connected to the overflow section is configured to receive a first slurry of solvent blend comprising dissolved carbon dioxide and an industrial alkali waste material,
wherein the plurality of different sections are configured to cause the first slurry to move within the apparatus with controlled fluid dynamics such that surface interaction between particles of the industrial alkali waste material and the solvent blend is increased to form a first solid carbonated slag in less than a predefined threshold time with a carbonation rate greater than a predefined threshold,
and wherein the underflow section is configured to release the first solid carbonated slag in a first stage and the overflow section is configured to concurrently regenerate and release the solvent blend devoid of carbon dioxide for reuse during the release of the first solid carbonated slag from the underflow section.
